(19) United States
(12) Patent Application Publication
(10) Pub. No.: US 2025/0263144 A1
(43) Pub. Date: Aug. 21, 2025

(54) ADJUSTABLE SEATPOST ARRANGEMENT FOR A BICYCLE

(71) Applicant: Inside Line, LLC, Taylors, SC (US)

(72) Inventor: Drew Coelho, Colorado Springs, CO (US)

(21) Appl. No.: 19/054,895

(22) Filed: Feb. 16, 2025

Related U.S. Application Data
(60) Provisional application No. 63/554,847, filed on Feb. 16, 2024.

(51) Int. Cl. B62J 1/08; B62J 45/00

(52) U.S. Cl. CPC B62J 1/08; B62J 45/00

(57) ABSTRACT

A seatpost assembly may generally include a lower post and an upper post movable relative to the lower post. The upper post is movable relative to the lower post between a high position and a low position. An actuation assembly is configured to receive a user input. A height change assembly is provided in conjunction with the actuation assembly. The height change assembly is operable to drive the upper post to the high position and to drive the upper post to the low position. The height change assembly may be operable responsive to receiving the user input and to drive the upper post to the low position responsive to receiving the user input.

### CROSS-REFERENCE TO RELATED APPLICATIONS

The present application claims the benefit of priority to U.S. Provisional Patent Application Ser. No. 63/554,847, filed on Feb. 16, 2024, the disclosure of which is incorporated by reference in its entirety.

### FIELD OF THE DISCLOSURE

The present disclosure relates to an adjustable seatpost arrangement for a bicycle. Specifically, the disclosure describes a seatpost arrangement that may be adjusted by a user between a number of seating heights. For example, an adjustable seatpost arrangement may be provided to facilitate a user to adjust to a desired seating height based on conditions and while riding the bicycle.

### BACKGROUND

A bicycle may generally be equipped with a seatpost arrangement. For example, a seatpost may be provided to support a seat or saddle relative to a frame of the bicycle. The seatpost arrangement may be received within a seatpost-receiving portion of the bicycle known as a seat tube. The seatpost arrangement and frame of the bicycle may be clamped in place to fix relative positions of the seatpost arrangement and the frame of the bicycle appropriate to a rider fit and bicycle geometry.

Maintaining an appropriate position of the saddle is an important task of the seatpost arrangement of a bicycle. A rider can be very sensitive to changes in saddle position. For example, while riding the bicycle on smooth, predictable terrain or when power output is of high importance (for example when climbing steep hills), a rider benefits from a saddle at a relatively high position to allow efficient power transfer and favorable pedaling biomechanics.

However, a saddle position (more particularly a saddle height) that is optimized for efficient pedaling is often not conducive to strong control of a bicycle. For example, when descending technical terrain, riding slowly, jumping, mounting, dismounting, or similar technical control situations, a relatively high saddle height limits rider movement relative to the bike. Adjustable seatpost arrangements generally allow a rider to make on-the-fly adjustments to saddle height, providing optimal pedaling efficiency and optimal bicycle control independently when each is needed.

As such, there is a need for an adjustable seatpost assembly that enables easy control between an optimal saddle height for pedaling efficiency and a saddle height that does not interfere with bicycle technical control. Such an adjustable seatpost assembly should be easy to operate between states with minimal rider input that may disrupt or distract from transitions between pedaling and technical riding.

### BRIEF DESCRIPTION

An object of this disclosure is to describe various adjustable seatpost arrangements configured to control saddle heights. An adjustable seatpost arrangement may be provided to allow a user to change between desired saddle heights on command, for example with a button or a switch.

One aspect of the disclosure provides a seatpost assembly including a lower post; an upper post movable relative to the lower post between a high position and a low position; an actuation assembly configured to receive a user input; and a height change assembly operable to drive the upper post to the high position responsive to receiving the user input and to drive the upper post to the low position responsive to receiving the user input.

Another aspect of the disclosure provides a seatpost assembly including: a seatpost comprising an upper post and a lower post, wherein the upper post is moveable relative to the lower post between a retracted position and an extended position; and a height change assembly coupled between the upper post and the lower post; wherein the height change assembly selectively drives the upper post from the extended position to the retracted position; and wherein the height change assembly selectively drives the upper post from the retracted position to the extended position.

Another aspect of the disclosure provides a seatpost assembly including: a lower post; an upper post movable relative to the lower post between a high position and a low position; and a height change assembly comprising a motor configured to drive the upper post between the high position and the low position.

Another aspect of the disclosure provides a seatpost assembly including: a seatpost positionable between an extended state and a retracted state; and an actuation assembly comprising an actuator, the actuator operably coupled to the seatpost, the actuator movable between a first position and a second position; wherein the seatpost moves from the extended state to the retracted state responsive to the actuator moving from the first position to the second position, and wherein the seatpost moves from the retracted state to the extended state responsive to the actuator moving from the first position to the second position.

Another aspect of the disclosure provides a method of positioning a seatpost between a plurality of states, the method including: receiving, at a height change assembly of the seatpost, a first input; causing, by the height change assembly, the seatpost to move from an extended state to a retracted state in response to the first input; receiving, at the height change assembly, a second input while the seatpost is in the retracted state; and causing, by the height change assembly, the seatpost to move from the retracted state to the extended state in response to the second input, wherein the first input and the second input are the same.

Another aspect of the disclosure provides a method of configuring a seatpost assembly between a plurality of states, the method including: switching a seatpost between an extended state and retracted state, wherein switching the seatpost includes: causing, by a height change assembly, a seatpost to move from an extended state to a retracted state in response to a first input; and causing, by the height change assembly, the seatpost to move from the retracted state to the extended state in response to a second input; wherein the seatpost is movable by the height change assembly between the extended state and the retracted state indefinitely prior to a servicing operation.

Another aspect of the disclosure provides a seatpost assembly including: a lower post having a non-circular cross-sectional shape; an upper post movable relative to the lower post between a high position and a low position; and a height change assembly operable to drive the upper post from the low position to the high position.

Another aspect of the disclosure provides a method of positioning a seatpost assembly between a plurality of states, the method including: storing, with an energy storage device, energy from a height change assembly; releasing, with a locking assembly, energy stored with the energy storage device; and storing, with the energy storage device, energy from the height change assembly responsive to the releasing of the energy stored with the energy storage device.

### BRIEF DESCRIPTION OF THE DRAWINGS

FIG. 1 is a side view of a road bicycle used to employ a seatpost arrangement.

FIG. 2 is a side view of an off-road bicycle used to employ a seatpost arrangement.

FIG. 3 is a schematic sectional view of a seatpost arrangement according to an embodiment shown in an extended position.

FIG. 4 is a schematic sectional view of the seatpost arrangement of FIG. 3 shown in a retracted position.

FIG. 5 is a schematic sectional view of a seatpost arrangement according to an embodiment shown in an extended position.

FIG. 6 is a schematic sectional view of the seatpost arrangement of FIG. 5 shown in a retracted position.

FIG. 7 is a front view of an embodiment of a height change assembly as shown in FIGS. 3 and 4

FIG. 8 is a partial front view of an embodiment of a height change assembly as shown in FIGS. 5 and 6.

FIG. 9 is a side sectional view of the height change assembly as shown in FIG. 8, taken along line 9-9 in FIG. 8.

FIG. 10 is a schematic sectional view of a seatpost arrangement according to an embodiment shown in an extended position and unloaded state.

FIG. 11 is a schematic sectional view of the seatpost arrangement of FIG. 10 shown in the extended position and preloaded state.

FIG. 12 is a schematic sectional view of the seatpost arrangement of FIG. 10 shown in a retracted position and unloaded state.

FIG. 13 is a schematic sectional view of the seatpost arrangement of FIG. 10 shown in the retracted position and preloaded state.

FIG. 14 is a schematic sectional view of a seatpost arrangement according to an embodiment shown in an extended position and unloaded state.

FIG. 15 is a schematic sectional view of the seatpost arrangement of FIG. 14 shown in the extended position and preloaded state.

FIG. 16 is a schematic sectional view of the seatpost arrangement of FIG. 14 shown in a retracted position and unloaded state.

FIG. 17 is a schematic sectional view of the seatpost arrangement of FIG. 14 shown in the retracted position and preloaded state.

FIG. 18a is a schematic view of a mechanical actuation assembly according to an embodiment in a first position.

FIG. 18b is a schematic view of the mechanical actuation assembly of FIG. 18A in a second position.

FIG. 19a is a schematic view of an electrical actuation assembly according to an embodiment in a first position.

FIG. 19b is a schematic view of the electrical actuation assembly of FIG. 19A in a second position.

FIG. 20 is a flow chart depicting a method of positioning a seatpost between a plurality of states.

FIG. 21 is a flow chart depicting a method of configuring a seatpost assembly between a plurality of states.

FIG. 22 is a flow chart depicting a method of positioning a seatpost assembly between a plurality of states.

Other aspects and advantages of the embodiments disclosed herein will become apparent upon consideration of the following detailed description, wherein similar or identical structures have similar or identical reference numerals.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations.

As used herein, the terms “first”, “second”, “third,” and the like may be used interchangeably to distinguish one component from another and are not intended to signify location or importance of the individual components.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As described herein, the term “seatpost” is used in reference to an assembly for use with a seat tube of a bicycle or similar structure. The seatpost described herein can be used with mountain bicycles, road bicycles, track bicycles, time-trial bicycles, triathlon bicycles, gravel bicycles, commuter bicycles, cargo bicycles, electric bicycles (e-bikes), tricycles, and other types of wheeled vehicles.

Adjustable seatposts described herein allow a user to adjust saddle height, e.g., when transitioning between climbing and descending. The adjustable seatpost (often referred to as a dropper post) includes a post formed from a plurality of segments that move relative to one another to adjust saddle height. It should be appreciated that an adjustable seatpost may be integrated with the frame of a bicycle, for instance by interfacing a height-adjustable seatpost component directly with a seat tube of a bicycle. Seatposts as described herein, and more particularly components of the seatposts described herein, are caused to operate in response to an actuation assembly that is user operable between two or more positions. The actuation assembly is mounted to a flat, a drop bar, a hood, or another portion of a handlebar and receives a user input which is communicated to the seat post through a linkage, such as a cable linkage or Bowden cable system, a hydraulic circuit, an electrical conductor (e.g. a wired electrical communication), a wireless connection (e.g., a transmitter/receiver communication system), or the like, causing a height change assembly of the seatpost to affect saddle height.

An adjustable seatpost arrangement may generally be provided to raise and lower a desired saddle height on command. For example, a rider may benefit from a high saddle height optimized for pedaling efficiency while climbing or riding on flat and predictable terrain. The same rider may also benefit from a low saddle height so that the saddle does not interfere with rider movement when pedaling efficiency is not required and/or during technical maneuvers like descending, jumping, dismounting, or mounting. It should also be appreciated that a rider may benefit aerodynamically by lowering the saddle height, for example when descending. A bicycle rider may need to alternate between high and low positions often, especially on variable terrain or in crowded city environment with repeated starting and stopping.

The embodiments generally shown and described herein may enable a rider to more easily adjust saddle height on demand. For example, adjustable seatpost arrangements herein provide a rider with the ability to command the saddle height to change with the press of a button or a switch. It is even contemplated that such command could be voice-operated, or even predictive based on riding data (e.g. accelerometer terrain data). Such commands may be chosen to allow a rider to raise and lower the adjustable seatpost arrangement without otherwise interfering with the riding of the bicycle. For example, embodiments as described herein would allow for full raising and lowering control of the adjustable seatpost arrangement without requiring direct force from the rider's body into the saddle, which may be disruptive to riding, particularly when entering a technical riding situation. Thus, embodiments as now described in further detail below provide the bicycle rider with fast, easy, and repeatable adjustment of saddle height so that pedaling efficiency and bicycle control can be effectively managed.

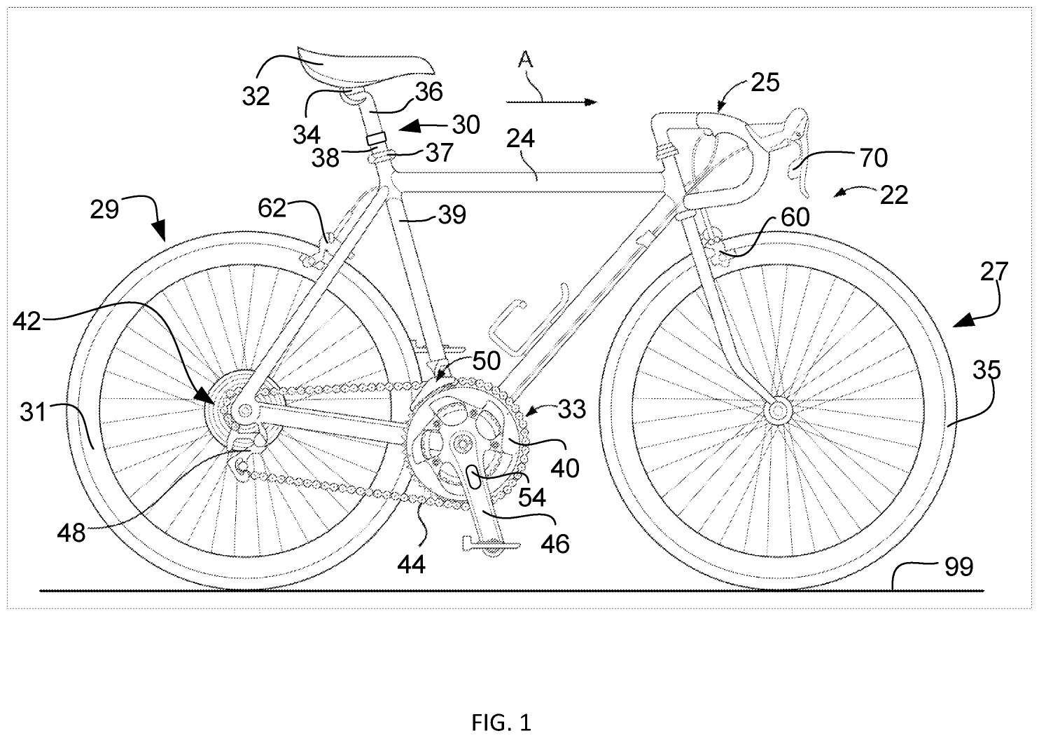

Referring now to the Drawings, FIG. 1 is a side view of a road-type configuration of a bicycle 22 used to employ an adjustable seatpost assembly 30. The bicycle 22 includes a frame 24, front and rear wheels 27, 29 rotatably attached to the frame 24, and a drive arrangement 33. A front brake 60 is provided for braking the front wheel 27 and a rear brake 62 is provided for braking the rear wheel 29. Each of the front and rear wheels 27, 29 includes a tire 35 attached to a rim 31, where the tire 35 is configured to engage a riding surface 99. A handlebar assembly 25 is provided for steering the front wheel 27. The direction of arrow “A” indicates a front and/or forward orientation of the bicycle 22, also referred to herein as a direction of travel A. As such, a forward direction of movement for the bicycle 22 corresponds to the direction A.

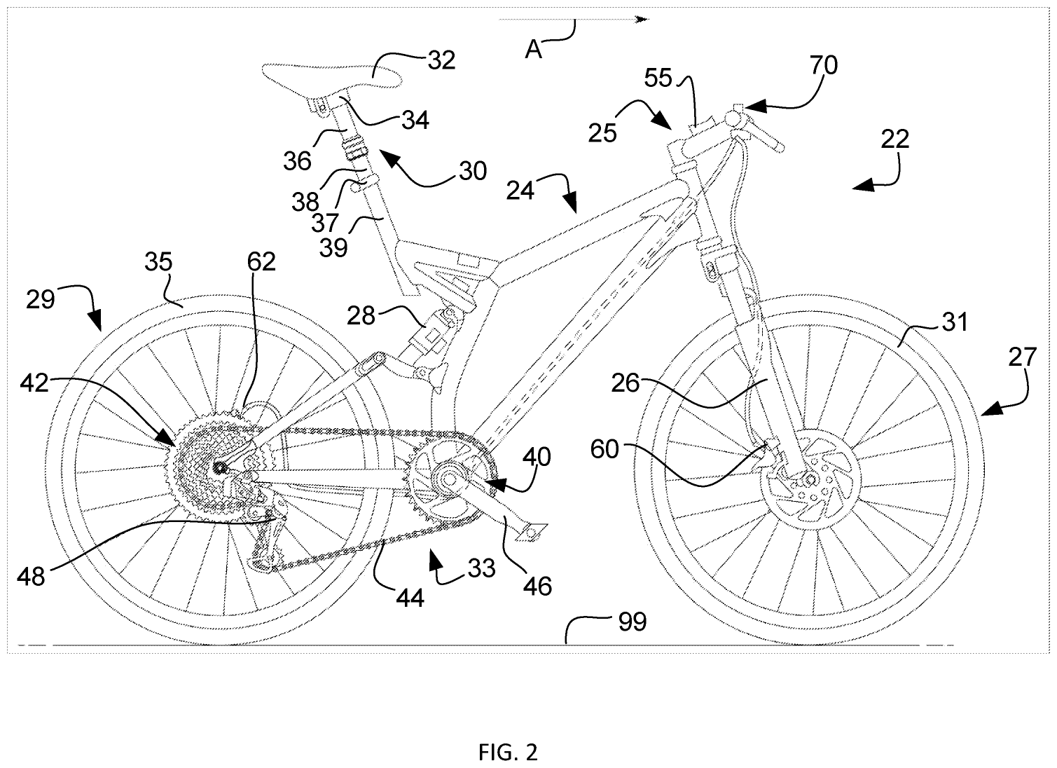

Other configurations of the bicycle 22 are contemplated. For instance, FIG. 2 depicts the bicycle 22 having a mountain-type or off-road configuration. Potential differences between bicycles of various configurations include those depicted between FIG. 1 and FIG. 2. For example, FIG. 1 depicts the handlebar assembly 25 in a drop-type configuration, whereas the example in FIG. 2 has a flat-type configuration of the handlebar assembly 25. It should be appreciated that different handlebar and tire types can be combined and furthermore include a wide spectrum of bicycle types, for example off-road drop-type handlebar bicycles sometimes referred to as gravel or cyclocross bicycles. The example in FIG. 2 also includes a front suspension 26 for movably mounting the front wheel 27 to the frame 24 and a rear suspension 28 for movably mounting the rear wheel 29 to the frame 24. The front and rear suspensions 26, 28 may include one or more of an adjustable suspension component such as a spring or damper. An adjustable seatpost assembly 30 is also shown in each of the examples in FIGS. 1 and 2 and is configured to movably attach a saddle 32 to the frame 24. The adjustable seating assembly 30 may include a saddle support structure 34 attachable to the saddle 32 and connected to an upper post 36. In various embodiments, the saddle support structure 34 may be configured to securely and adjustably secure saddle rails (not shown) of the saddle 32. The upper post 36, the saddle support structure 34, and the saddle 32 may be configured to move relative to a lower post 38 fixedly attached to the frame 24. For example, the lower post 38 may be clamped into the frame 24 with a seat clamp 37. In some embodiments, the upper post 36 may ride within the lower post 38, where the lower post 38 is fixed to a seat tube 39 of the frame 24. It should also be appreciated that in some embodiments, the seat tube 39 of the frame 24 may also serve as the lower post 38 of the adjustable seatpost assembly 30.

FIGS. 1 and 2 each depict an embodiment of the drive arrangement 33 including a drive sprocket assembly 40 rotatably mounted to the frame 24, a driven sprocket assembly 42 mounted to the rear wheel 29, and a chain 44 engaging the drive sprocket assembly 40 and the driven sprocket assembly 42, which may be a rear sprocket assembly. The drive sprocket assembly 40 may be attached to a crank 46 to facilitate torque transfer from a rider to the rear wheel 29 through the drive sprocket assembly 40, to the chain 44, and to the driven sprocket assembly 42.

The chain 44 may be shifted through a plurality of driven sprockets of the driven sprocket assembly 42 with a rear gear changer 48 as depicted. The plurality of driven sprockets of the driven sprocket assembly 42 may be arranged by radius, for example each further outboard sprocket having a smaller radius than the last. The chain 44 may also be shifted through a plurality of drive sprockets of the drive sprocket assembly 40 with a front gear changer 50 as shown in FIG. 1. The plurality of drive sprockets of the drive sprocket assembly 40 may be arranged by radius, for example each further outboard drive sprocket having a larger radius than the last. Alternatively, as in FIG. 2, the front gear changer 50 may be omitted as when the drive sprocket assembly 40 consists of one of a solitary drive sprocket 40.

As shown in FIGS. 1 and 2, it is contemplated that various sensors may be provided on the bicycle 22. For example, a drivetrain sensor 54 may be provided, as shown in FIG. 1. The drivetrain sensor 54 may include a torque sensor, accelerometer, a speed sensor, a cadence sensor, or any combination of those or similar sensors. For example, the drivetrain sensor 54 may be used to detect a pedaling state which in turn may be used to control other components of the bicycle 22, such as the adjustable seatpost assembly 30 as discussed in further detail below. In an exemplary embodiment, the drivetrain sensor 54 may be operable to detect a pedaling state indicative of required pedaling efficiency and transmit a signal to raise the adjustable seatpost assembly 30 to a high position. Additionally or alternatively, the drivetrain sensor 54 may be operable to detect a pedaling state indicative of coasting or minimal output and responsively transmit a signal to lower the adjustable seatpost assembly 30 to a low position.

Further sensors may be provided, as shown in FIG. 2 for example which includes a frame sensor 55. The frame sensor 55 may be operable to detect a motion state of the bicycle 22 indicative of a desired saddle height and transmit a signal to operate the adjustable seatpost assembly 30 accordingly. For example, the frame sensor 55 may include an accelerometer, vibration detector, gyroscope, or other sensing device and may be used to indicate a terrain condition. In an exemplary embodiment, the frame sensor 55 may detect a motion state of the bicycle 22 indicative of a rough and/or descending terrain condition and responsively transmit a signal to lower the adjustable seatpost assembly 30 to a low position. Additionally or alternatively, the frame sensor 55 may detect a motion state of the bicycle 22 indicative of a smooth and/or ascending terrain condition and responsively transmit a signal to raise the adjustable seatpost assembly 30 to a high position.

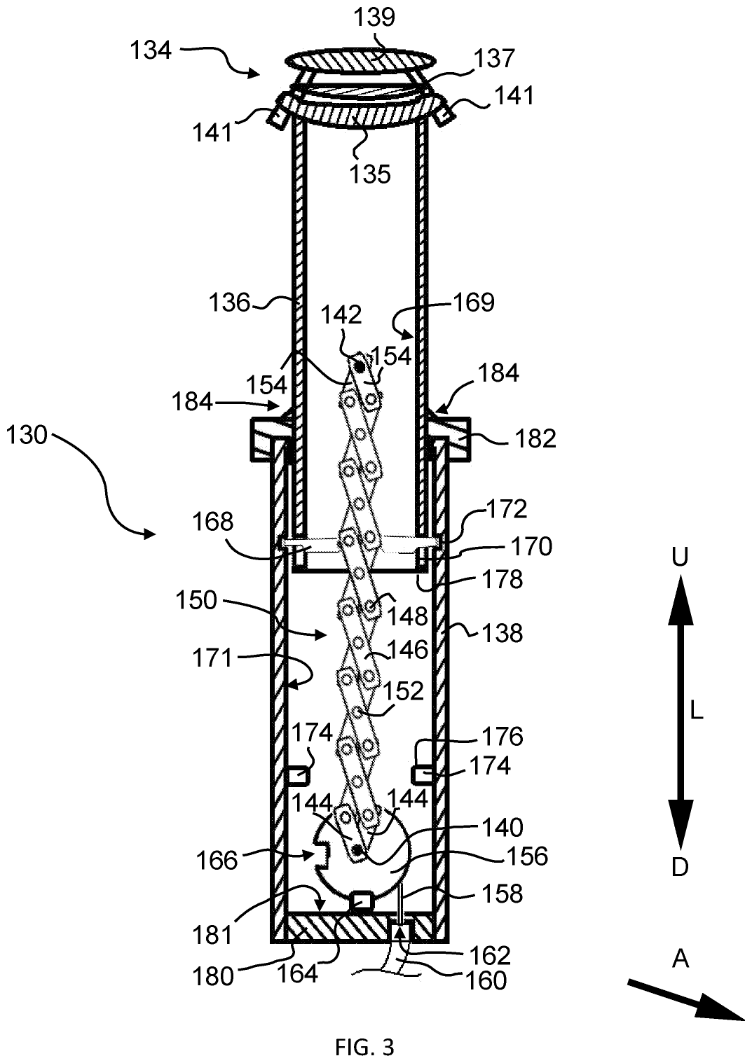

Referring now to FIG. 3, an embodiment of an adjustable seatpost assembly 130 is depicted in an extended position. As shown, the adjustable seatpost assembly 130 includes a lower post 138 and an upper post 136. The lower post 138 is configured to be received in a bicycle frame, for example sized and shaped to be received in the seat tube 39 of a bicycle according to the exemplary embodiments of FIGS. 1 and 2. It should be appreciated that the lower post 138 may be shaped with a cross-sectional shape generally matching that of the receiving component of the bicycle. For example, the lower post 138 may have a generally round cross-section, such as a circular cross-section. In various embodiments, the lower post 138 may have a non-circular cross-section, for example a teardrop cross-section or a D-shaped cross-section. Such non-circular cross-sections may be employed for frame compatibility, aerodynamics, compliance/suspension effect, and/or rotation prevention.

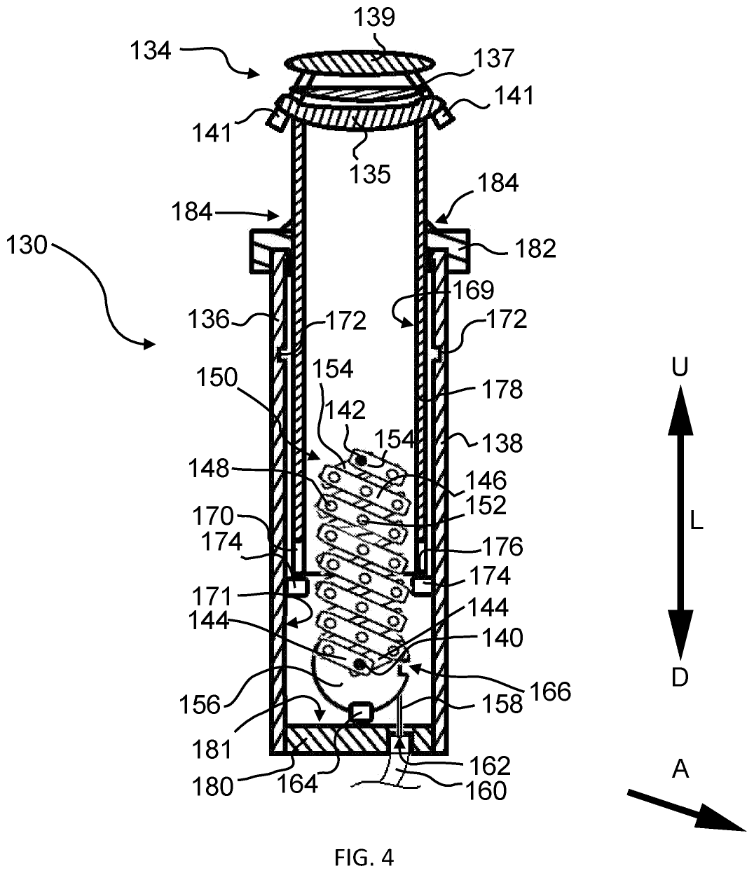

As shown in FIG. 3, the upper post 136 is configured to move relative to the lower post 138. For example, the upper post 136 as shown is slidably movable relative to the lower post along a longitudinal axis L of the adjustable seatpost assembly 130. As such, the upper post 136 is translatable along the longitudinal axis L. The upper post 136 as shown in FIG. 3 is presently in a high position, which may also be referred to as a raised position, or an extended position or state, with these terms being used interchangeably. As shown in FIG. 4, the upper post 136 is movable to a low position, which may also be referred to as lowered position, or a retracted position or state, with these terms being used interchangeably. It should be appreciated that a plurality of intermediate states where the upper post 136 is somewhere between the high position and the low position may also be provided. These intermediate states may represent fixed operational states or transient/transitional states between operational states. In at least one embodiment, an intermediate position of the upper post 136 is provided as a service position, for example where access to one or more components allows for service or disassembly.

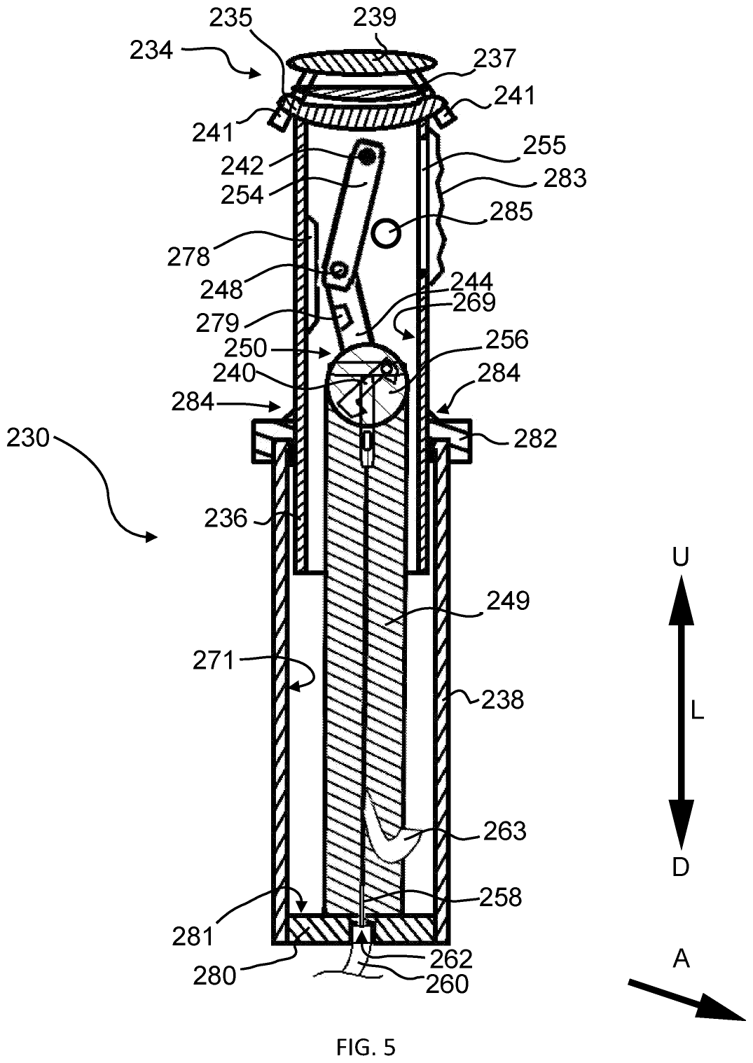

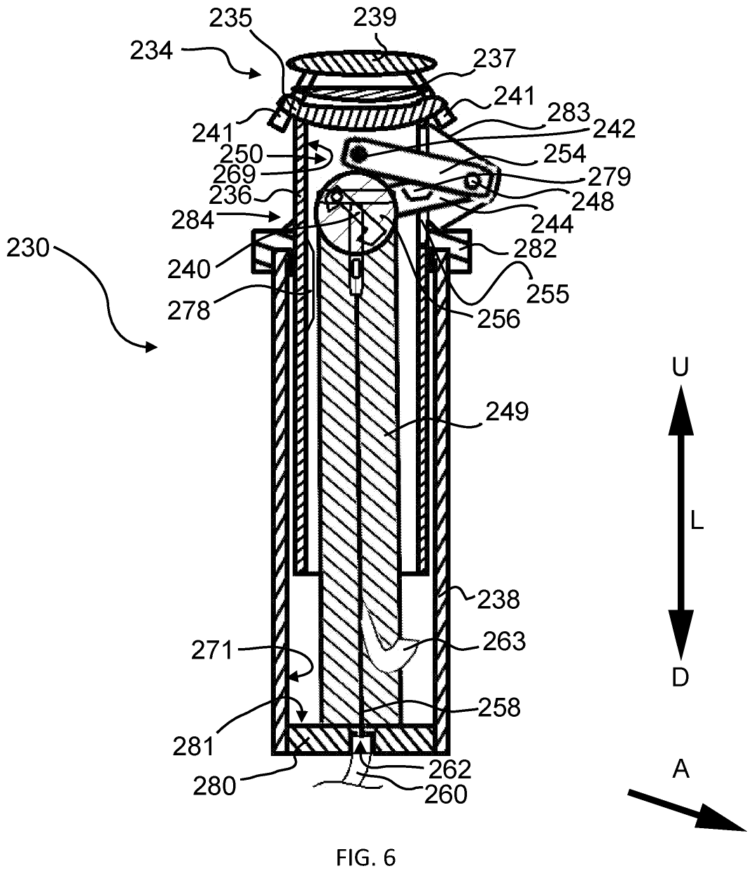

Still referring to FIG. 3, a height change assembly 150 is provided in the adjustable seatpost assembly 130. As shown, the height change assembly 150 is entirely contained within a volume defined by the adjustable seatpost assembly 130. Specifically, the height change assembly 150 is entirely contained within a volume defined by the upper and lower posts 136 and 138. However, it should be appreciated that in some embodiments the height change assembly may be at least partially disposed outside of the adjustable seatpost assembly 130, for example as shown in FIGS. 5 and 6 discussed in greater detail below.

The height change assembly 150 as shown in FIG. 3 is operable to drive the upper post 136 to the high position shown in FIG. 3 and is operable to drive the upper post 136 to the low position shown in FIG. 4. It should be appreciated that various intermediate positions exist between the high and low positions. In some embodiments, the adjustable seatpost assembly 130 is configured to toggle between the high and low positions and only lock in these discrete positions as riding positions. In other embodiments, the adjustable seatpost assembly may be configured to lock in one or more intermediate positions to provide intermediate riding position(s) and/or intermediate service position(s).

As shown in FIG. 3, the height change assembly 150 is disposed between the upper post 136 and the lower post 138. Movement of the upper post 136 may be described with reference to a longitudinal travel path L. For example, movement of the upper post 136 from the low or retracted position to the high or extended position occurs in an upward direction U along the longitudinal travel path L. Movement of the upper post 136 from the extended or high position to the retracted or low position occurs in a downward direction D along the longitudinal travel path L. As shown, movement in the downward direction D may generally include a component of movement (lateral expansion) in the direction of travel A, while movement in the upward direction U may generally include a component of movement (lateral retraction) opposite the direction of travel A.

Still referring to FIG. 3, the height change assembly 150 as shown is connected to both the upper post 136 and to the lower post 138. The height change assembly 150 is connected to the lower post 138 with a lower height change connection 140. The height change assembly 150 is connected to the upper post 136 with an upper height change connection 142. The lower height change connection 140 and the upper height change connection 142 may be achieved with various structures, but as shown include respective pin structures, fixing a pivot point while allowing rotation of one or more components of the height change assembly 150 relative to the upper post 136 and/or the lower post 138.

In FIG. 3, a lower primary arm 144 attaches to the lower height change connection 140. As shown, the lower primary arm 144 pairs with another lower primary arm 144, which may provide for tuning of weight and strength characteristics. It should be appreciated that any number of one or more lower primary arms 144 and corresponding similar arm or linkage structures described herein may be combined. The lower primary arms 144 as shown cooperate with upper primary arms 154. As described herein, the lower primary arms 144 and the upper primary arms 154 are generally coupled, and may be coupled directly (see, e.g. FIGS. 5 and 6) or may be coupled through one or more secondary arms 146, including a plurality of secondary arms 146 as shown in FIG. 3.

Still referring to FIG. 3, the lower primary arms 144 and the upper primary arms 154 are coupled together by a plurality of secondary arms 146. As shown, the secondary arms 146 are arranged in sets, each set including two of the plurality of secondary arms 146. The lower primary arms 144 and the upper primary arms 154 are each coupled to the secondary arms 146 through an arm outside pivot 148. Further, each set of secondary arms 146 is connected to an adjacent set through the arm outside pivots 148. As shown between FIGS. 3 and 4, movement of the height change assembly 150 through its travel results in movement of the arm outside pivots 148 along the longitudinal travel path L and orthogonally to the longitudinal travel path L (i.e. radially inwards and outwards from an axis defined by movement of the upper post 136 along the longitudinal travel path L). In some embodiments, such orthogonal movement of the arm outside pivots 148 may be used to regulate locking and unlocking, as discussed in greater detail below. As shown, each set of the secondary arms 146 may be connected with an arm center pivot 152. The movement of the height change assembly 150 through its travel results in movement of the arm center pivots 148 generally along the longitudinal travel path L. In FIGS. 3 and 4, no movement outside of the longitudinal travel path L is traveled by the arm center pivots 148.

Arrangements like that described in the paragraph directly above may generally be referred to as a scissor linkage. In such scissor linkage arrangements, the plurality of secondary arms 146 may be identical, for example to save in production cost or aid in assembly and repair. In other embodiments, individual ones of the plurality of secondary arms 146 may be tuned for various characteristics including strength, weight, rotational inertia, frictional resistance, or compliance concerns (e.g., to provide a suspension effect in one or more positions).

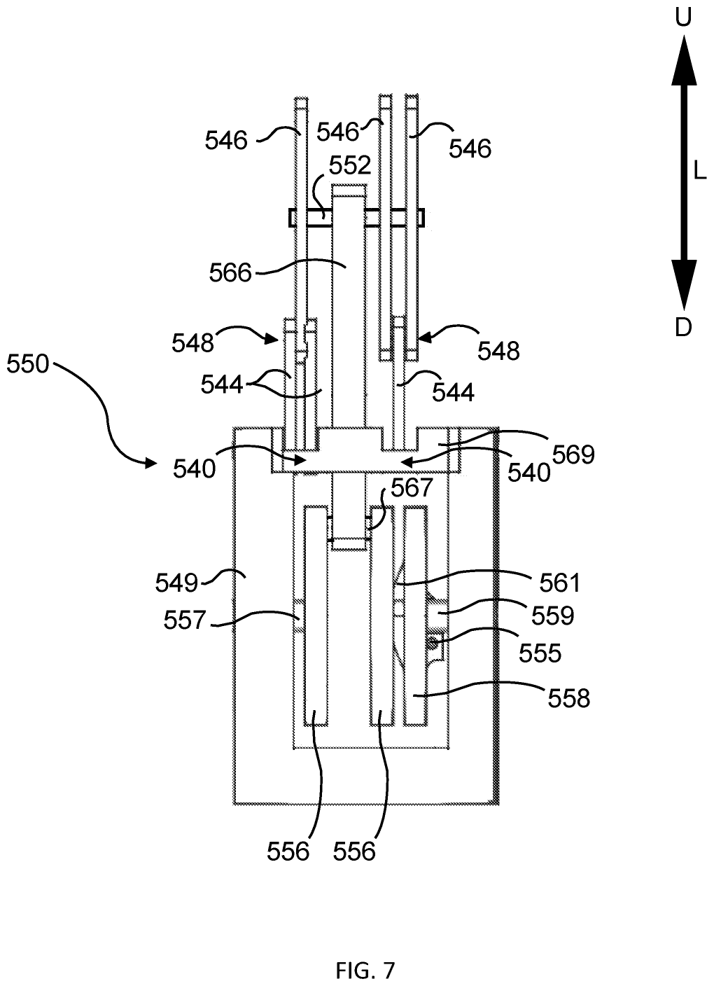

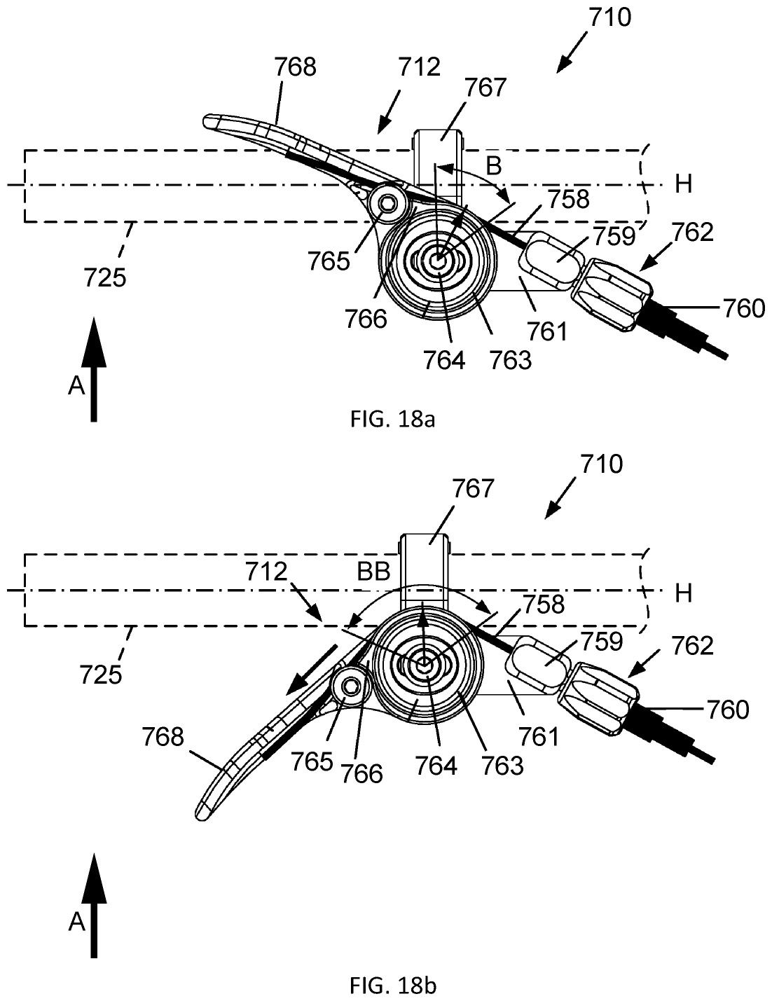

Still referring to FIG. 3, the height change assembly 150 includes a driving wheel 156. As will be discussed in further detail with reference to FIG. 7 below, the driving wheel 156 may be driven by a cable 158 directly or through one or more further structures. The cable 158 shown may generally be of a Bowden cable type, traveling through a cable housing 160. As shown, the cable housing terminates in a post housing stop 162. In this arrangement, the effective length of the cable 158 operating between the post housing stop 162 and further structures can be controlled. For example, an actuation assembly (see, e.g. FIGS. 18A, 18b) may selectively pull and release or push the cable 158. As shown in FIG. 3, the cable 158 interacts with the height change assembly 150 to rotate the driving wheel 156. Rotation of the driving wheel 156 is linked with rotation of at least one other component of the height change assembly 150 so as to drive the linkage as described above including the lower primary arms 144, the upper primary arms 154, and the secondary arms 146. For example, a connecting rod may be provided to drive an arm center pivot 152 as shown in greater detail with reference to FIG. 7 below.

Various structures may be employed to control rotation of the driving wheel 156. For example, a locking detent 164 may be provided to maintain a position of the driving wheel 156. As shown, the locking detent 164 may be configured to interact with one or more corresponding features on the driving wheel 156, such as a driving wheel locking recess 166. The locking detent 164 may serve to lock the adjustable seatpost assembly 130 in the upper position, the lower position, or one or more other positions. In some embodiments, the locking detent 164 may serve as a secondary locking device, where at least one further locking device serves to handle loads applied to the adjustable seatpost assembly 130. For example, the locking detent 164 may be configured as a rolling detent tunable to resist rotation during reset operations of the driving wheel 156 while not strong enough to transmit dangerous loads to the height change assembly 150. Such a configuration of the locking detent 164 may be described as an embodiment of a clutch for the height change assembly 150 to prevent damage. As such, the locking detent 164 may be tuned to unlock or to allow slip at a threshold condition. The threshold condition may be described as a predefined force or impulse level beyond which damage to one or more components may occur.

Still referring to FIG. 3, one or more locking structures may interact directly between the upper post 136 and the lower post 138. For example, a linkage lock assembly 168 may be provided to lock the upper post 136 to the lower post 138 in at least one position. As shown, the linkage lock assembly 168 extends generally orthogonally relative to the longitudinal travel path L with raising of the adjustable seatpost assembly 130. The linkage lock assembly 168 shown interfaces with one or more secondary arms 146 and/or arm outside pivots 148 such that opposing locking features extend outward and generally perpendicularly to movement of the arm center pivots 152. For example, a right-hand side secondary arm 146 may control a portion of the linkage lock assembly 168 extending to the left-hand side of the adjustable seatpost assembly 130 and a left-hand side secondary arm 146 may control a portion of the linkage lock assembly 168 extending to the right-hand side of the adjustable seatpost assembly 130. Corresponding features of the linkage lock assembly 168 may be sized and shaped to interface with locking features on one or more of the upper post 136 or the lower post 138. For example, the depicted configuration allows the linkage lock assembly 168 to extend through at least one of an upper post recess 170 formed in an upper post inner surface 169 and into at least one of a lower post recess 172 formed in a lower post inner surface 171. Thus, the linkage lock assembly 168 may serve to directly lock the upper post 136 to the lower post 138 without unduly loading further components of the height change assembly 150.

Although the above-described configuration of the linkage lock assembly 168 serves to lock in the upper, high, or extended position of the adjustable seatpost assembly 130, it should further be appreciated that the linkage lock assembly 168 may be further configured to lock in additional positions, including the lower, low, or retracted position. For example, as shown with reference to FIG. 4, where components of the linkage lock assembly 168 are generally hidden within a collapsed scissor linkage arrangement, further linkage lock components (not shown) could be configured to extend to the right-hand side from the right-hand side components of the linkage and vice-versa, thus extending to lock through the upper post 136 and the lower post 138 in this lower position.

Referring again to FIG. 3, additional locking structures may yet be provided to selectively lock the upper post 136 in one or more positions. For example, a low stop 174 may be provided to prevent movement beyond the low position of the adjustable seatpost assembly 130. As shown, the low stop includes at least one low stop surface 176 sized and shaped to impinge upon the upper post 136 at or below the low position of the adjustable seatpost assembly 130. The upper post 136 as shown includes an upper post stop surface 178 sized and shaped to interface with the low stop surface 176 of the low stop 174. As shown, the low stop 174 may be connected to or integral with lower post 138. For example, the low stop 174 may be disposed on the lower post inner surface 171 in which the lower post recess 172 is formed. As described, the embodiment shown in FIG. 3 provides for selectively locking the upper post 136 in the high position with the linkage lock assembly 168 and selectively locking the upper post in the low position with the low stop 174. Furthermore, the locking detent 164 may additionally provide locking in each of these positions, for example to resist upward movement of the upper post 136 from the low position shown in FIG. 4.

The low stop 174 may further be attached to a bottom cap 180. The bottom cap 180 may generally be removable from the adjustable seatpost assembly 130. For example, the bottom cap 180 may be threaded and/or pinned to the lower post 138. The bottom cap 180 may serve as a carrier for various components, including the height change assembly 150. For example, various components may interface directly or indirectly with a bottom cap inside surface 181 of the bottom cap 180. As shown in FIGS. 3 and 4, and with further detail in FIG. 7, the driving wheel 156 may be attached to the bottom cap 180 through the lower height change connection 140. Accordingly, removal of the bottom cap 180 can facilitate removal of the height change assembly 150 for service.

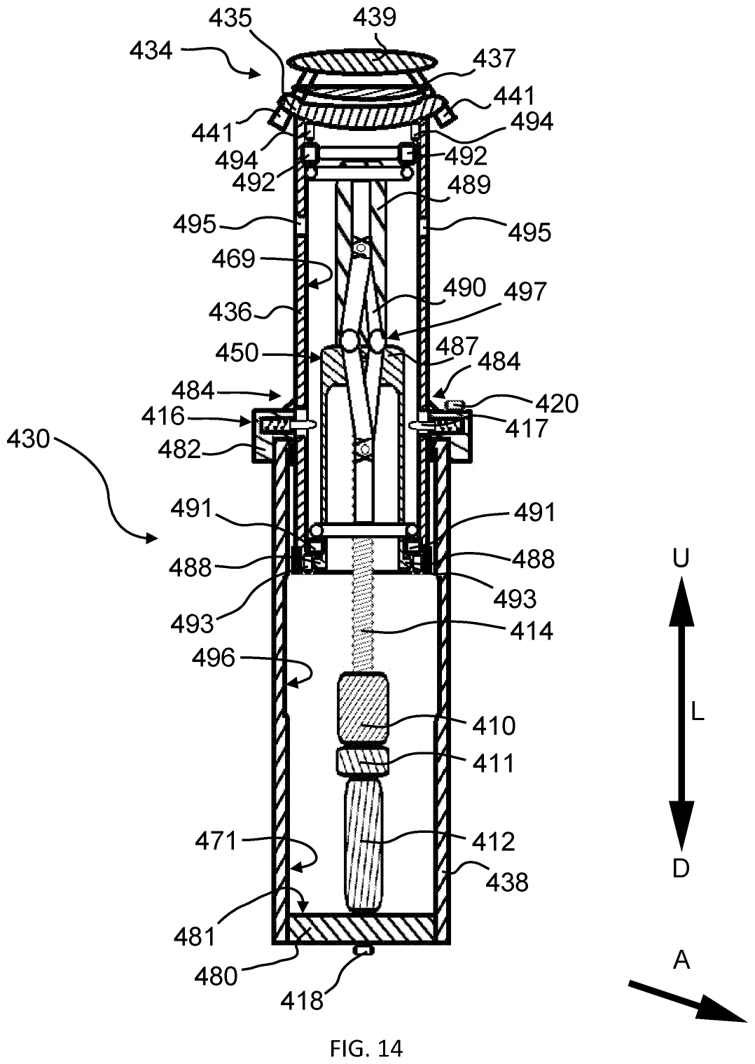

Still referring to FIG. 3, an endcap 182 may be provided between the upper post 136 and the lower post 138. As shown, the endcap 182 is removably coupled to the lower post 138, for example through a threaded connection. It should be appreciated that a pinned, slotted, or otherwise indexed configuration may be used, for example where relative rotation of the endcap 182 is important (i.e. non-circular cross-section embodiments and/or embodiments including locking features in an endcap such as that described with reference to FIGS. 14-17). The endcap 182 may further include one or more features to restrain movement of the upper post 136 in the high position, for example to prevent over-extension. In such a configuration, the endcap 182 may be removable to facilitate removal of the upper post 136 from the lower post 138.

Also shown in FIG. 3, a post seal assembly 184 may be provided. The post seal assembly 184 may include a seal, such as a lip or wiper seal, disposed circumferentially about the upper post 136 and configured to resist intrusion of environmental debris into the volume defined within the upper post 136 and the lower post 138. Further features of the post seal assembly 184 may include debris clearances, lubricating rings, debris scrapers, etc. As shown, the post seal assembly 184 may be connected to or integrated with the endcap 182. Accordingly, the endcap 182 may be removable to facilitate service or replacement of at least a portion of the post seal assembly 184.

The arrangement described with reference to FIG. 3 above may be used to repeatedly drive the upper post 136 between its extended and retracted positions (shown in FIGS. 3 and 4, respectively) using mechanical input from the cable 158. Accordingly, the height change mechanism 150 used herein may rely solely on this mechanical input to drive the upper post 136 both in the upward direction U and in the downward direction D along the longitudinal travel path L. Such a configuration may thus be free of external power sources or stored potential energy including but not limited to pre-compressed springs, pressure vessels, capacitors, or batteries. Such a configuration may also facilitate movement of the upper post 136 by the height change assembly 150 indefinitely prior to a servicing operation, for example 100, 1000, or 10,000 repetitions. It should be appreciated that a servicing operation may be necessary depending on environmental contamination but independent of loss of power or stored energy.

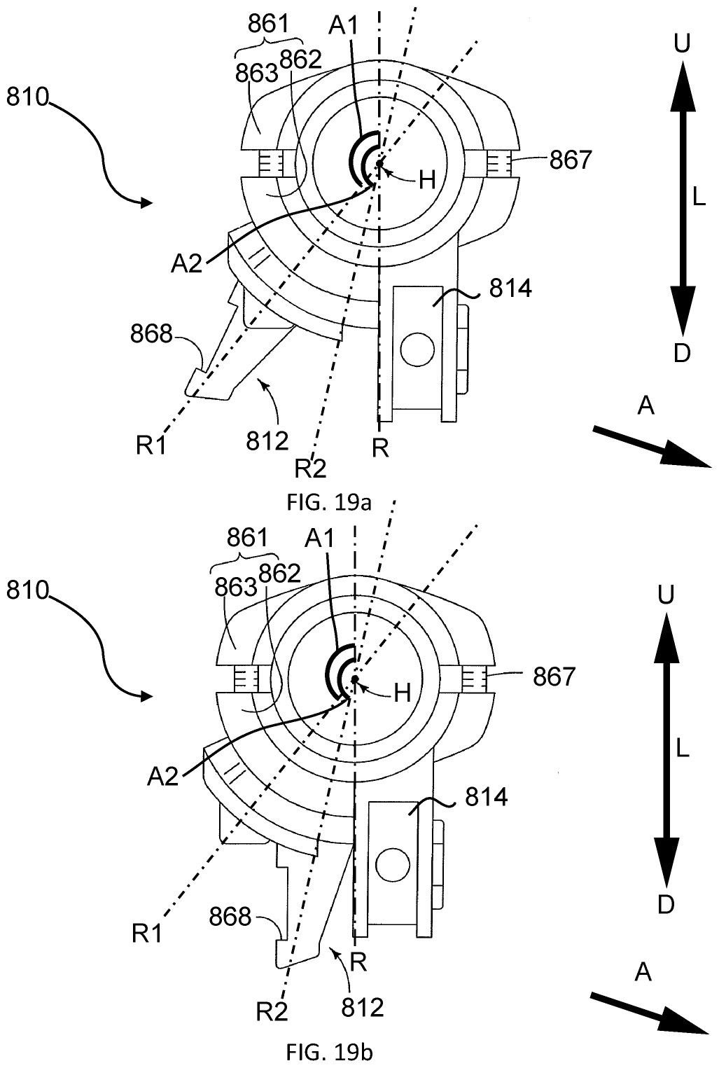

The driving of the upper post 136 relative to the lower post 138 is achieved by movement of the height change assembly 150 as shown in FIGS. 3 and 4. As discussed in greater detail below, for example with reference to FIGS. 18A and 18b, the height change assembly 150 may operate to drive the upper post 136 responsive to one or more user inputs, for example directly from a seatpost input device (not shown) on the adjustable seatpost assembly 130 or from an actuation assembly as shown in FIGS. 18A, 18b, 19a, and/or 19b.

The movement of the upper post 136 in turn is used to move a saddle (see FIGS. 1 and 2). Referring again to FIG. 3, the upper post 136 includes a saddle support structure 134. The saddle support structure 134 is generally configured to accept a bicycle seat or saddle and control its relative position to the upper post 136. As shown, the saddle support structure 134 includes a saddle reference structure 135 fixed relative to the upper post 136. For example, the saddle reference structure 135 may be integral to the upper post 136 and used to define a relationship between the attached saddle and the adjustable seatpost assembly 130. Beyond the saddle reference structure, a lower saddle clamp 137 and an upper saddle clamp 139 may be provided and fastened with one or more of a saddle clamp fastener 141. This arrangement may be used to finely adjust and fix a desired angle and/or fore-aft position of the saddle (not shown) relative to the adjustable seatpost assembly 136, for example by clamping to a set of saddle rails (not shown) fixed to the saddle (not shown).

Still referring to FIG. 3, the saddle support structure 134 may as described above be at least in part fixed to the upper post 136. Accordingly, once a saddle (not shown) is mounted, the saddle and saddle support structure 134 may move along the longitudinal travel path L with the upper post 136 between the low and high positions of the adjustable seatpost assembly 130. It should be appreciated that a relative position, including angle and fore-aft positioning, of the saddle (not shown) and saddle support structure 134 may be maintained through the travel of the adjustable seatpost assembly 130 along its entire movement along the longitudinal travel path L. Thus, an angle of the saddle (not shown) and its saddle support structure 134 in a fastened state, measured with respect to the longitudinal axis of the adjustable seatpost assembly (i.e. the longitudinal travel path L centered around the lower post 138 and/or the upper post 136), can be maintained the same with the upper post 136 in the high position, in the low position, and in one or more intermediate positions between the high and low positions.

Referring now to FIG. 4, the adjustable seatpost assembly 130 as described above is depicted in the retracted position. As shown by the adjustment of the upper post 136 from FIG. 3 to FIG. 4, the height change assembly 150 is operable to drive the adjustable seatpost to the low position. For example, the cable 158 may be pulled to operate the driving wheel 156, which in turn drives the lower primary arms 144. As shown between FIGS. 3 and 4, the driving wheel 156 may generally rotate approximate one hundred eighty (180) degrees between up and down positions. In such an embodiment, driving of the height change assembly 150 through the driving wheel 156 may toggle between upper and lower positions with successive rotations in the same direction (i.e. a clockwise direction). It should also be appreciated that a height change assembly 150 may also be configured with any number of discrete rotational positions corresponding to up and down positions of the adjustable seatpost assembly 130 per revolution of the driving wheel 156. For example, the driving wheel 156 may be configured to raise or lower the upper post 136 with each successive rotation of ninety (90) degrees.

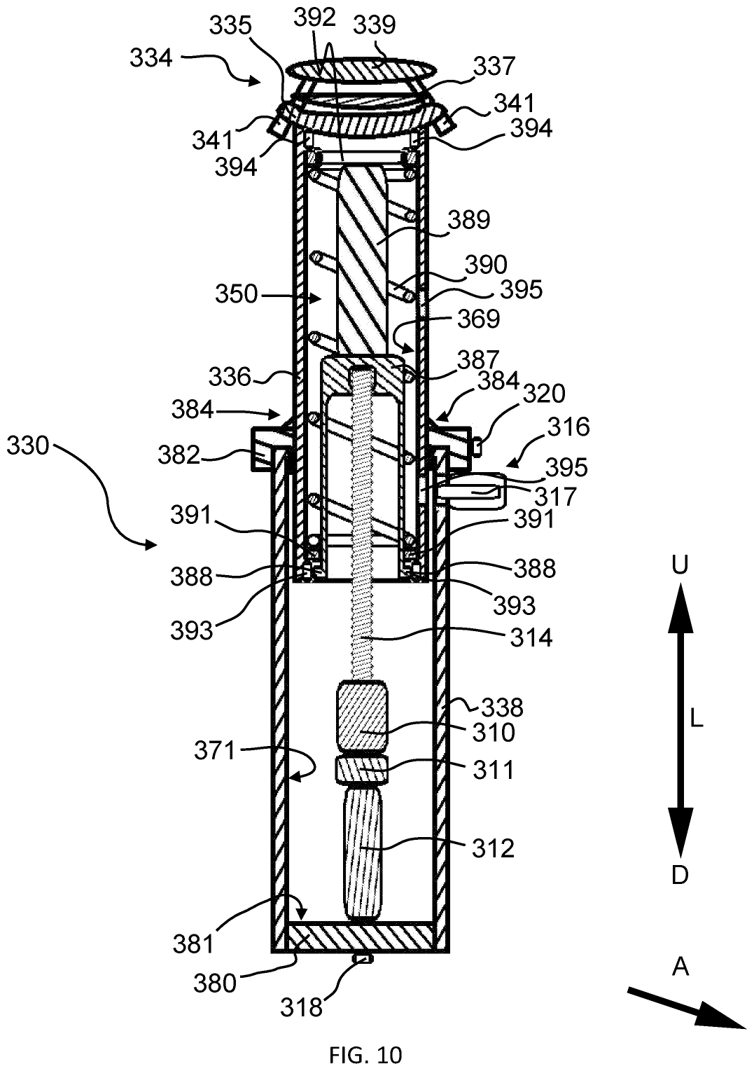

Between FIGS. 3 and 4, it is shown that the linkage defined by the lower primary arms 144, the upper primary arms 154, the secondary arms 146, the arm outside pivots 148, and the arm center pivots 152 expands and collapses with driving of the driving wheel 156. Accordingly, the height change assembly 150 as described provides driven movement from the lower position to the upper position and from the upper position to the lower position. As the driving wheel 156 is driven, for example in a single rotational direction as described above, the lower primary arms 144 rotate, with the secondary arms 146 rotating responsive to this rotation, and further with the upper primary arms 154 rotation responsive to this rotation. Although the driving wheel 156 as shown in FIGS. 3 and 4 is actuated by a pull of the cable 158, it should be appreciated that various other structures may be used additionally or alternatively to provide motive force to the driving wheel 156 and the height change assembly 150 generally. For example, a motor, for example as described with reference to FIGS. 10-17, may be provided to directly or indirectly drive the driving wheel 156.

Still referring to FIG. 4, it should be appreciated that the height change assembly 150 may also serve to provide resistance to relative rotation between the upper post 136 and the lower post 138. As shown, the rotational orientation of the height change assembly 150 may be fixed through the upper height change connection 142 at the upper post 136 and through the lower height change connection 140 at the lower post 138. Additionally or alternatively, further anti-rotation features may be provided. For example, the upper post 136 and/or the lower post 138 may be provided with a generally non-circular cross-section to resist rotation, may be rotationally keyed relative to one another, or may be keyed relative to another structure such as the endcap 182. In an embodiment, a plurality of rotational keys ride between corresponding features in at least one of the upper post 136 and the lower post 138.

Turning now to FIG. 5, an embodiment of an adjustable seatpost assembly 230 is depicted in an extended position. The adjustable seatpost assembly 230 of FIG. 5 depicts a height change assembly 250 movable at least in part external to a volume defined within an upper post 236 and a lower post 238 of the adjustable seatpost assembly 230. As in other embodiments, the upper post 236 includes a saddle support structure 234. The saddle support structure 234 is generally configured to accept a bicycle seat or saddle and control its relative position to the upper post 236. As shown, the saddle support structure 234 includes a saddle reference structure 235 fixed relative to the upper post 236. For example, the saddle reference structure 235 may be integral to the upper post 236 and used to define a relationship between the attached saddle and the adjustable seatpost assembly 230. Beyond the saddle reference structure 235, a lower saddle clamp 237 and an upper saddle clamp 239 may be provided and fastened with one or more of a saddle clamp fastener 241. This arrangement may be used to finely adjust and fix a desired angle and/or fore-aft position of the saddle (not shown) relative to the adjustable seatpost assembly 230, for example by clamping to a set of saddle rails (not shown) fixed to the saddle (not shown).

Still referring to FIG. 5, operation of the height change assembly 250 results in a driving force acting on the saddle support structure 234 through the upper post 236 in the upward direction U or the downward direction D along the longitudinal travel path L. The upper post 236 may be constrained along the longitudinal travel path L between upper and lower positions, for example by stop features provided on the lower post 238 and/or an endcap 282. A sealing arrangement, for example as described above with reference to FIGS. 3 and 4, may be provided as a post seal assembly 284, which may further be connected to or integrated with the endcap 282.

In FIG. 5, the height change assembly 250 is mounted or mountable on a bottom cap 280, and specifically to a bottom cap inside surface 281. The bottom cap 280 may be removable, for example threadably removable, to facilitate assembly, disassembly, and/or service. The height change assembly 250 shown may also be spaced apart from a lower post inner surface 271 of the lower post 238 and from an upper post inner surface 269 of the upper post 236. This spaced apart configuration facilitates movement of the upper post 236 between at least a portion of the height change assembly 250 and the lower post inner surface 271 of the lower post 238 throughout the travel of the upper post 236. As shown, the bottom cap 280 may provide control of one or more communication or transmission structures from an actuation device (not shown). For example, the bottom cap 280 may be shaped and sized, for example with a post housing stop 262, to control a cable housing 260 for running a cable 258 therethrough. Accordingly, the bottom cap 280 may facilitate a driving force imparted from the cable 258 and constrained cable housing 260 to act upon the height change assembly 250, for example upon a driving wheel 256 of the height change assembly 250. Additionally or alternatively, an internal housing stop 263 may be provided to control the cable housing 260. For example, the internal housing stop 263 may facilitate routing of the cable housing 260 into the volume defined between the upper post 236 and the lower post 238. The internal housing stop 263 may also provide additional cable routing options. For example, providing both the internal housing stop 263 and the post housing stop 262 as shown in FIG. 5 may facilitate cable routing through the bicycle seat tube (known as “internal” or “stealth” routing) and external routing without directly entering the bicycle frame. Such a configuration may thus be versatile between both application without modification.

The driving wheel 256 of FIGS. 5 and 6 is supported with a wheel support structure 249 and may generally be configured as the driving wheel described with reference to FIGS. 3 and 4. Alternatively, the driving wheel 256 may be configured differently. For example, the driving wheel 256 depicted in FIGS. 5 and 6 may generally be rotatable in two opposite rotational direction. In an embodiment, one extreme rotational position of the driving wheel 256 in a first direction corresponds with the upper position of the adjustable seatpost assembly 230 (i.e. shown in FIG. 5) and another extreme rotational position of the driving wheel 256 in a second direction, opposite the first direction, corresponds with the lower position of the adjustable seatpost assembly 230 (i.e. shown in FIG. 6). Further description of possible configurations of the driving wheel 256 (and the driving wheel 156 of FIGS. 3 and 4) may be found with reference to FIGS. 7-9 below.

Still referring to FIG. 5, a lower arm 244 may be provided in connection with the lower post 238 and an upper arm 254 may be provided in connection with the upper post 236. As shown, the lower arm 244 attaches to the lower post 238 through a lower height change connection 240, for example connected to the driving wheel 256 as described above. The upper arm 254 may connect through various structure(s) to the upper post 236 with an upper height change connection 242. As shown, the upper arm 254 is coupled to the upper post 236 with a pinned configuration of the upper height change connection 242 and the lower arm 244 is coupled to the lower post (through the driving wheel 256) with a pinned configuration of the lower height change connection 240. The lower arm 244 and the upper arm 254 may be directly connected to one another, for example through an inter-arm pivot 248 as shown in FIG. 5. As such, the lower arm 244 may be rotatably coupled with the upper arm 254 about a rotational axis defined by the inter-arm pivot 248. Such a rotational axis may generally be orthogonal to the lifting axis of the adjustable seatpost assembly 230 along the longitudinal travel path L. Although not shown, a spring (e.g., a torsional spring) or other biasing arrangement may be provided to bias the upper arm 254 and the lower arm 244 relative to one another, for example to counter a gravitational force. The spring or other biasing arrangement can be tuned in view of saddle weight, attached accessories, rider preference, or the like.

As shown between FIGS. 5 and 6, the upper arm 254 is generally configured to drive the upper post 236 responsive to driving of the lower arm 244. Specifically, the upper arm 254 is configured to rotate relative to the upper post 236 responsive to rotation of the lower arm 244 relative to the lower post 238. The lower arm 244 is shown to include an arm stop surface 279 configured to control movement of the upper post 236. For example, as shown in FIG. 6, the arm stop surface 279 interacts with the upper arm 254 (for example at a complimentary stop surface) to resist further movement in the downward direction of the upper post 236. In an embodiment, the arm stop surface 279 is configured as a suspension component, for example with an elastomeric construction to facilitate suspension motion of the upper post 236. The elastomeric construction can be tuned, for example in view of rider weight, terrain type, or the like to provide suspension motion with the adjustable seatpost assembly 230 in the lower position.

Also shown in FIGS. 5 and 6, the upper post 236 may be provided with a post stop surface 278 to control movement of the upper post 236. As shown in FIG. 5, the post stop surface 278 may control movement of the upper post 236 by constraining movement of the lower arm 244 and/or the upper arm 254. In an embodiment, the post stop surface 278 is configured as an elastomeric stop and may provide a suspension effect. The post stop surface 278 can be tuned, for example in view of rider weight, terrain type, or the like to provide suspension effect with the adjustable seatpost assembly 230 in the raised position. Tuning can be performed, for example, by swapping between different post stop surface materials during servicing, or even on demand while riding. In an embodiment, the adjustable seatpost assembly 230 can include a lockout that prevents suspension effect via the post stop surface 278. As shown, the post stop surface 278 is sized and shaped to allow inversion or “knee locking” of the lower arm 244 and the upper arm 254. Accordingly, the lower arm 244 and the upper arm 254 may be used to lock the upper post 236 in the upper position, with unlocking achievable by slightly raising the upper post 236 with operation of the driving wheel 256. It should be appreciated that one or more secondary locking features, for example a detent lock on the driving wheel 256 may resist unintentional unlocking at the upper position of the upper post 236.

The adjustable seatpost assembly 230 of FIG. 5 further depicts a service access opening 285. The service access opening 285 can be part of the upper post 236. As shown, the service access opening 285 facilitates disassembly of the adjustable seatpost assembly 230 by removal of the upper post 236 and associated components from the lower post 238 and associated components. In the depicted embodiment, the service access opening 285 is disposed such that, at an intermediate position between the upper and lower positions along the longitudinal travel path L, the service access opening 285 aligns with the inter-arm pivot 248. At this intermediate position (i.e. a service position), the inter-arm pivot 248 may be removable, for example with a tool or else toollessly, thus disconnecting the upper arm 254 from the lower arm 244. It should be appreciated that this embodiment of the service access opening 285 is exemplary and that further positions may be provided and that other disassembly points, such as the lower height change connection 240 and/or the upper height change connection 242 may be provided. In an embodiment, the service access opening 285 aligns with the inter-arm pivot 248 at a position above the inverted “knee locked” upper position to facilitate disassembly. Such various configuration may all be employed to allow servicing internal components of the adjustable seatpost assembly 230, for example the height change assembly 250 while the lower post 238 is disposed in, such as locked in, the seat tube 39 of the bicycle 22 (see, e.g. FIGS. 1 and 2). That is, the seatpost assembly 230 may be serviced while one or more portions thereof (such as the lower post 238) remain connected (fixed) to the bicycle 22.

Still referring to FIG. 5, further openings into the volume defined by the upper post 236 and the lower post 238 may be provided. For example, as shown in FIGS. 5 and 6, an arm clearance opening 255 may be provided to facilitate movement of at least a portion of the height change assembly 250 beyond the volume defined by the upper post 236 and the lower post 238. As shown in FIG. 5, the height change assembly 250 may be entirely contained within the volume defined by the upper post 236 and the lower post 238 when the upper post 236 is in the raised position. As shown in FIG. 6, at least a portion of the upper arm 254, the lower arm 244, and the inter-arm pivot 248 may exit the volume defined by the upper post 236 and the lower post 238 through the arm clearance opening 255 when the upper post 236 is in the lower position. It should also be appreciated that the arm clearance opening 255 may also be used to perform service operations, such as disconnection of the upper arm 254 from the lower arm 244 as described above with reference to the service access opening 285.

FIG. 6 shows the inter-arm pivot 248 disposed entirely external to the volume defined by the upper post 236 and the lower post 238. In this arrangement, an arm seal arrangement 283 may be provided to resist debris entry into the volume defined by the upper post 236 and the lower post 238. As shown, the arm seal arrangement 283 may be a flexible, for example an elastomeric, covering over the arm clearance opening 255. In an embodiment, the arm seal assembly 283 provides a force to the height change assembly 250. For example, the arm seal assembly 283 as shown in FIG. 6 may provide a spring force on the inter-arm pivot 248, biasing the lower arm 244 and the upper arm 254 in opposing rotational directions around the inter-arm pivot 248 and biasing the upper post 236 towards the raised position. The arm seal assembly 283 may be disconnectable from the upper post 236 to allow entry into the volume through the arm clearance opening 255. For example, the arm seal assembly 283 may be captured at the upper post 236 by a clamp retention feature, one or more threaded fasteners engageable with the upper post 236, an adhesive or hook and loop type fastener, a magnetic interface, or a tongue and groove arrangement. In some instances, the arm seal assembly 283 remains coupled to the upper post 236 and includes an opening which may be selectively opened and closed to permit access to the arm clearance opening 255.

Referring to FIG. 6, the adjustable seatpost assembly 230 is depicted in the retracted position. It should be noted that angles of the lower arm 244 and the upper arm 254 relative to the longitudinal travel direction L generally increase upon moving from the extended position to the retracted position. For example, the raised position depicted in FIG. 5 shows the lower arm 244 and the upper arm 254 close to parallel with the longitudinal travel direction L while the lowered position depicted in FIG. 6 shows the lower arm 244 and the upper arm 254 close to perpendicular with the longitudinal travel direction L.

Turning now to FIG. 7, a front sectional schematic view of a height change assembly 550 is depicted. It should be appreciated that the height change assembly 550 as depicted generally corresponds to that depicted in FIGS. 3 and 4, but may be applicable to various embodiments described herein as with other height change assemblies described. As shown in FIG. 7, the height change assembly 550 is external to any adjustable seatpost assembly, for example prior to assembly or during a service procedure. A wheel support structure 549 is provided to support various components of the height change assembly 550. For example, the wheel support structure 549 depicted is configured to mount a driving wheel 556 with a driving wheel shaft 557 and a ratchet wheel 558 with a ratchet wheel shaft 559. The height change assembly 550 may also be mountable to a lower post (for example a bottom cap inside surface as described with reference to FIGS. 3-6 and 10-17) or may be integral with a lower post.

As shown in FIG. 7, the ratchet wheel 558 is actuatable through an actuation interface 555. The actuation interface 555 may be configured as a cable stop or a pinch bolt or the like for controlling a cable as described with reference to FIGS. 3-6 above. Alternatively or additionally, the actuation interface 555 may be a motorized interface. Through the actuation interface 555, the ratchet wheel 558 is rotatably driven responsive to a user input. The ratchet wheel 558 in turn drivingly interacts with the driving wheel 556 through a ratchet interface 561 as shown. The ratchet interface 561 depicted in FIG. 7 is an axial ratchet interface including sprung pawls, however it should be appreciated that various other ratchet interfaces, including radial ratchet interfaces may be provided. For example, a radial ratchet interface may be disposed radially between the ratchet wheel 558 and the driving wheel 556, where the ratchet wheel 558 and the driving wheel 556 axially overlap with respect to the ratchet wheel shaft 559 and/or the driving wheel shaft 557.

Responsive to rotation of the driving wheel 556 in FIG. 7, a connecting rod 566 is driven through a connecting rod pivot 567. The connecting rod 566 in turn drives a linkage assembly, here shown as including lower primary arms 544, secondary arms 546, arm outside pivots 548, and an arm center pivot 552 through which the connecting rod 566 is drivably connected with the linkage assembly. Movement of the connecting rod may be constrained at least in part by a wheel support cap 569, which in turn may provide mounting points for the linkage assembly, for example through a lower height change connection 540 at one or more of the lower primary arms 544.

Still referring to FIG. 7, rotation of the ratchet wheel 558 may be achieved through the actuation interface 555. Upon relaxing of driving force from the actuation interface 555, the ratchet wheel 558 may be configured to return to an origin position, for example under force of one or more return springs. The driving wheel 556 is configured such that it generally rotates with the driven rotation of the ratchet wheel 558 but not with such return rotation of the ratchet wheel 558. For example, various locking mechanisms as described throughout may maintain the driving wheel 556 in position during return of the ratchet wheel 558 to its origin position. Accordingly, the driving wheel 556 may rotate unidirectionally with successive driving rotations of the ratchet wheel 558, for example to achieve approximately one hundred eighty (180) degrees of rotation with successive actuations of the ratchet wheel 558.

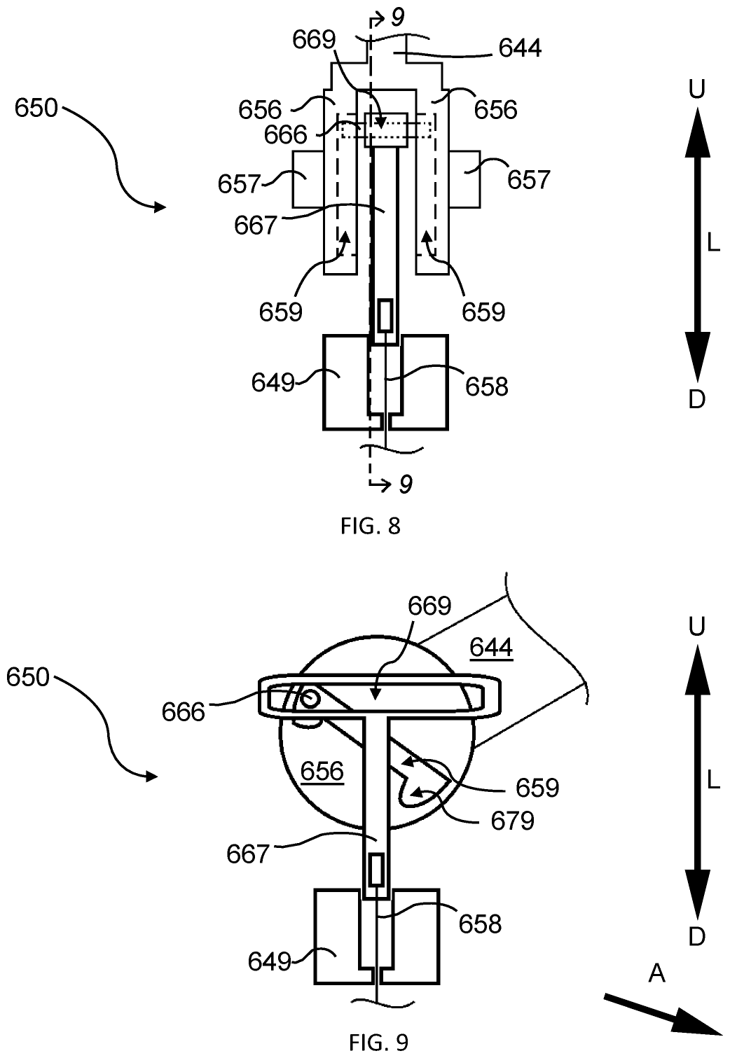

Turning now to FIG. 8, a close-up schematic view of a height change assembly 650 is depicted. Although the embodiment shown in FIGS. 8 and 9 generally corresponds with that depicted in FIGS. 5 and 6, it should be appreciated that the height change assembly 650 as described herein is generally applicable to various embodiments. As shown, the height change assembly 650 includes a driving wheel 656 supported by a wheel support structure 649 through at least one driving wheel shaft 657. The driving wheel shaft 657 may be arranged in this configuration to have bearing surfaces configured to interface with bearings (not shown) disposed in the wheel support structure 649. Driving of the driving wheel 656 in turn drives a lower arm 644. Driving of the driving wheel 656 may be accomplished by a motor or other drive arrangement, or through an actuation shaft 667 controlled with a cable 658 as shown in FIGS. 8 and 9.

Operation of the actuation shaft 667 with the cable generally provides driven motion of the actuation shaft 667 in one direction, where the actuation shaft 667 may return under return force (for example through a return spring arrangement) when actuation force is released. As shown, the actuation shaft 667 operates drivingly in the downward direction D and returns in the upward direction U. Movement of the actuation shaft 667 in turn affects the driving wheel 656 through constraint of an actuation rod 666 in an actuation shaft slot 669 of the actuation shaft 667 and in a driving wheel slot 659 of the driving wheel 656.

Referring now to FIG. 9, a side sectional view taken along line 9-9 in FIG. 8 is depicted. As shown in FIG. 9, movement of the actuation shaft 667 through a driving force from the cable 658 may in turn rotate the driving wheel 656. For example, the actuation shaft slot 669 is moved in the downward direction D, in turn moving the actuation rod 666 in the downward direction D. In this example, downward movement of the actuation rod 666 results in its capture in a driving wheel slot travel feature 679 of the driving wheel 656. The driving wheel slot travel feature 679 constrains the actuation rod 666, ensuring further driven movement in the downward direction D results in rotation of the driving wheel 656 about its driving wheel shaft 657 and associated axis. Additionally, the driving wheel slot travel feature 679 may serve to allow movement of the actuation shaft 667 independent of rotation of the driving wheel 656, for example to lower a locking bar or detent (not shown) locking the driving wheel 656. Continued driven movement in the downward direction D results in a complete rotation of the driving wheel 656. For example, where FIG. 9 may show an analogous operational position to the downward position of FIG. 6, complete rotation of the driving wheel 656 by the actuation shaft 667 moving in the downward direction D in FIG. 9 may toggle to an analogous operational position to the upward position of FIG. 5. It should be appreciated that various detent or locking mechanisms as described elsewhere herein may be employed to maintain the rotational position of the driving wheel 656 during resetting operation of the actuation shaft 667 and the actuation rod 666, for example to resist friction of the actuation rod 666 traveling up and across the driving wheel slot 659.

Turning now to FIG. 10, a schematic sectional view of an adjustable seatpost assembly 330 is shown in an extended position and unloaded state. The adjustable seatpost assembly 330 of FIG. 10 depicts a height change assembly 350 that is both drivable and loadable or pre-loadable, as described in greater detail below. As in other embodiments, a lower post 338 is configured to mount to a bicycle frame and an upper post 336 includes a saddle support structure 334. The saddle support structure 334 is generally configured to accept a bicycle seat or saddle and control its relative position to the upper post 336. As shown, the saddle support structure 334 includes a saddle reference structure 335 fixed relative to the upper post 336. For example, the saddle reference structure 335 may be integral to the upper post 336 and used to define a relationship between the attached saddle and the adjustable seatpost assembly 330. Beyond the saddle reference structure 335, a lower saddle clamp 337 and an upper saddle clamp 339 may be provided and fastened with one or more of a saddle clamp fastener 341. This arrangement may be used to finely adjust and fix a desired angle and/or fore-aft position of the saddle (not shown) relative to the adjustable seatpost assembly 336, for example by clamping to a set of saddle rails (not shown) fixed to the saddle (not shown).

In FIG. 10, the height change assembly 350 is mounted or mountable on a bottom cap 380, and specifically to a bottom cap inside surface 381. The bottom cap 380 may be removable, for example threadably removable, to facilitate assembly, disassembly, and/or service. The height change assembly 350 shown may also be spaced apart from a lower post inner surface 371 of the lower post 338 and from an upper post inner surface 369 of the upper post 336. This spaced apart configuration facilitates movement of the upper post 336 between at least a portion of the height change assembly 350 and the lower post inner surface 371 of the lower post 338 throughout the travel of the upper post 336. As shown, the bottom cap 380 may provide control of one or more communication or transmission structures from an actuation device (not shown). Operation of the height change assembly 350 results in a driving force acting on the saddle support structure 334 through the upper post 336 in the upward direction U or the downward direction D along the longitudinal travel path L. The upper post 336 may be constrained along the longitudinal travel path L between upper and lower positions, for example by stop features provided on the lower post 338 and/or an endcap 382. A sealing arrangement, for example as described above with reference to FIGS. 3-6 may be provided as a post seal assembly 384, which may further be connected to or integrated with the endcap 382.

Still referring to FIG. 10, the height change assembly 350 is depicted as a motorized height change assembly. Accordingly, the height change assembly 350 includes a motor 310 controlled by a motor controller 311 and powered by a motor power source 312 (such as a battery). The motor 310 is operable to drive an output shaft 314. The output shaft 314 is configurable to provide driving force to the adjustable seatpost assembly 330 through various structures. As shown in FIG. 10, the output shaft 314 is configured to drive a carrier 387. The carrier 387 as shown is operable to drive the upper post 336 relative to the lower post 338. As described in greater detail below, the carrier 387 may be configured to drive an energy storage device 390 which in turn may selectively drive the upper post 336 upwards and/or downwards. Selective control of the energy storage device 390 may be achieved with a locking assembly 316. As shown, the locking assembly 316 includes at least one locking feature 317 operable to lock the upper post 336 relative to the lower post 338. As such, the locking assembly 316 facilitates preloading of the adjustable seatpost assembly 330 with the energy storage device 390 and releasing of preloaded energy from the energy storage device 390 with operation of the locking assembly 316. As shown, the locking assembly 316 is configured to interact with one or more locking passages 395. For example, the locking feature 317 may be sized and shaped to selectively insert into and retract from a first set of the locking passages 395 to lock the adjustable seatpost assembly 330 in the extended position and a second set of the locking passages 395 to lock the adjustable seatpost assembly 330 in the retracted position.

Communication to the height change assembly 350 may be effected through one or more communication features. As shown in FIG. 10, an internal communication feature 318 may be provided on the lower post 338 for internal or stealth routing and/or an external communication feature 320 may be provided on the upper post 336, an upper portion of the lower post 338, or the endcap 382 as shown. The communication features 318, 320 may generally accept routing of electrical conductors to send and/or receive signals and/or power between the adjustable seatpost assembly 330 and another component such as an actuation assembly shown in FIGS. 19A and 19b.

As will be discussed in greater detail below with reference to FIGS. 10-13, the motor 310 is configured to impart a driving force on the energy storage device 390 through the carrier 387 and a tension device 389. The carrier 387 may facilitate driving energy into the energy storage device 390 for release in the upward direction U and the tension device 389 may facilitate driving energy into the energy storage device in the downward direction D. As shown in FIG. 10 with the energy storage device 390 in an unloaded state, an energy storage device lower carrier 391 maintains the energy storage device 390 above an energy storage device lower stop 393 fixed to the lower post 338. Similarly, an energy storage device upper carrier 392 maintains the energy storage device below an energy storage device upper carrier 392.

It should be appreciated that while the state in FIG. 10 is herein referred to as an unloaded state, the energy storage device 390 may still be under load. For example, a coil spring embodiment of the energy storage device 390 may be preloaded in this unloaded state between the energy storage device lower stop 393 and the energy storage device upper stop 394 while still not being actively loaded through operation of the motor 310. Generally speaking, driving operation of the carrier 387 in the upward direction U drives a carrier stop 388 upwards into the energy storage device lower carrier 391 to move it off of the energy storage device lower stop 393 to store energy for a lifting operation. Driving operation of the tension device 389 in the downward direction D drives the energy storage device upper carrier 392 downwards to move it off of the energy storage device upper stop 394 to store energy for a lowering operation. As discussed in greater detail below, the tension device 389 and the carrier 392 are configured so as to not interfere with the driving operation of the other.

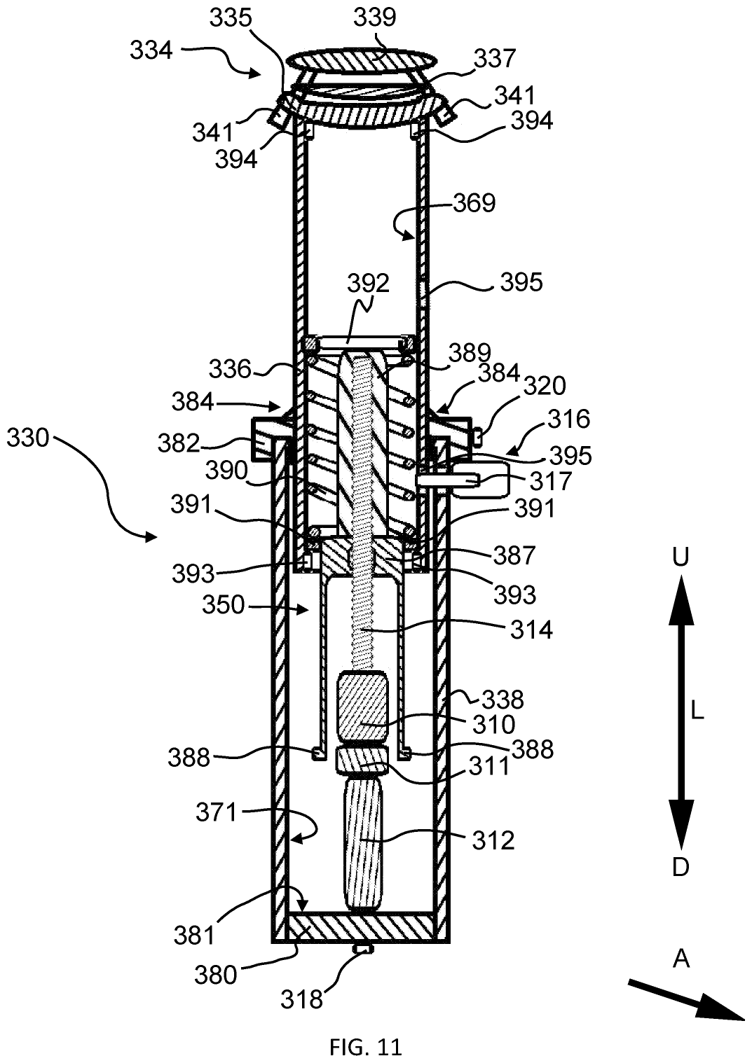

As shown between FIGS. 10 and 11, the height change assembly 350 is operable to load (i.e., preload) the energy storage device 390 without moving the upper post 336 relative to the lower post 338. To move from the state in FIG. 10 to that in FIG. 11, first the locking assembly 316 is controlled to lock the upper post 336 relative to the lower post 338 with the locking feature 317 extending through the upper post 336 and the lower post 338, for example through corresponding ones of the locking passage 395. With the upper and lower posts 336 and 338 locked together, the motor 310 then drives the carrier 387 and the tension device 389 connected thereto in the downward direction D along the longitudinal travel path L through operation of the output shaft 314. The energy storage device 390 in turn compresses, storing energy for later release. Although the energy storage device 390 as shown is a coil spring, it should be appreciated that such a configuration could also be achieved with other types of energy storage, for example air springs.

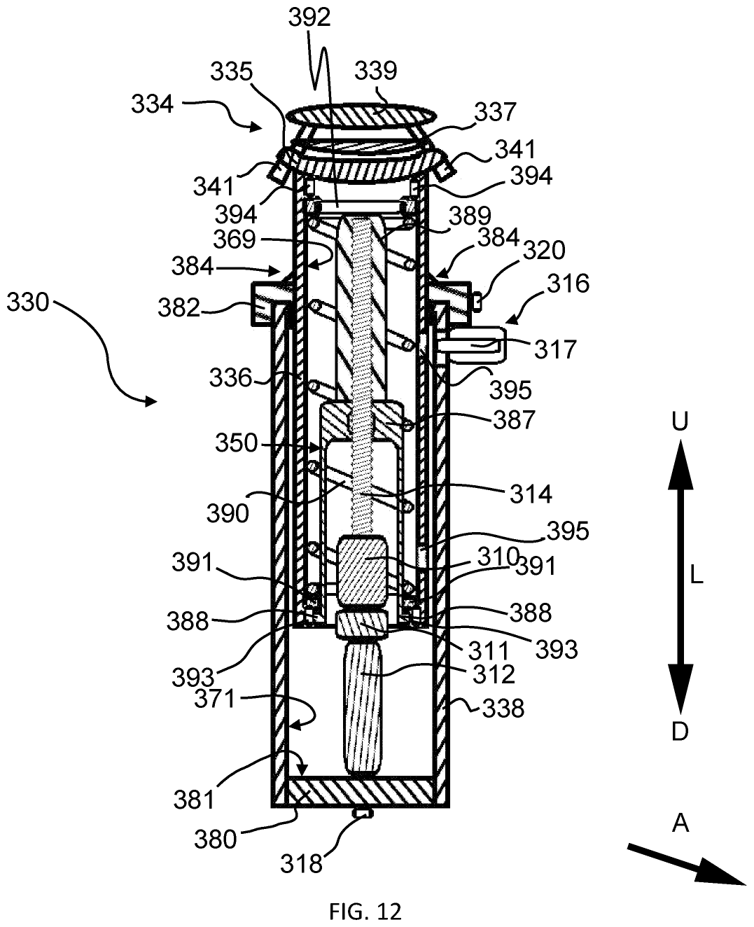

The change between FIG. 10 and FIG. 11 may be effected automatically, for example responsive to arriving at the state of FIG. 10. That is, the energy storage device 390 may be automatically preloaded such that release can be rapidly achieved when commanded by a rider. As shown with the change in state from FIG. 11 to FIG. 12, this release may be achieved by unlocking the locking assembly 316. As the energy storage device 390 is constrained relative to the lower post 338 through its energy storage device upper carrier 392, unlocking in the raised and preloaded state shown in FIG. 11 results in driving of the upper post 336 in the downward direction D along the longitudinal travel path L, ending in the lowered and unloaded state shown in FIG. 12.

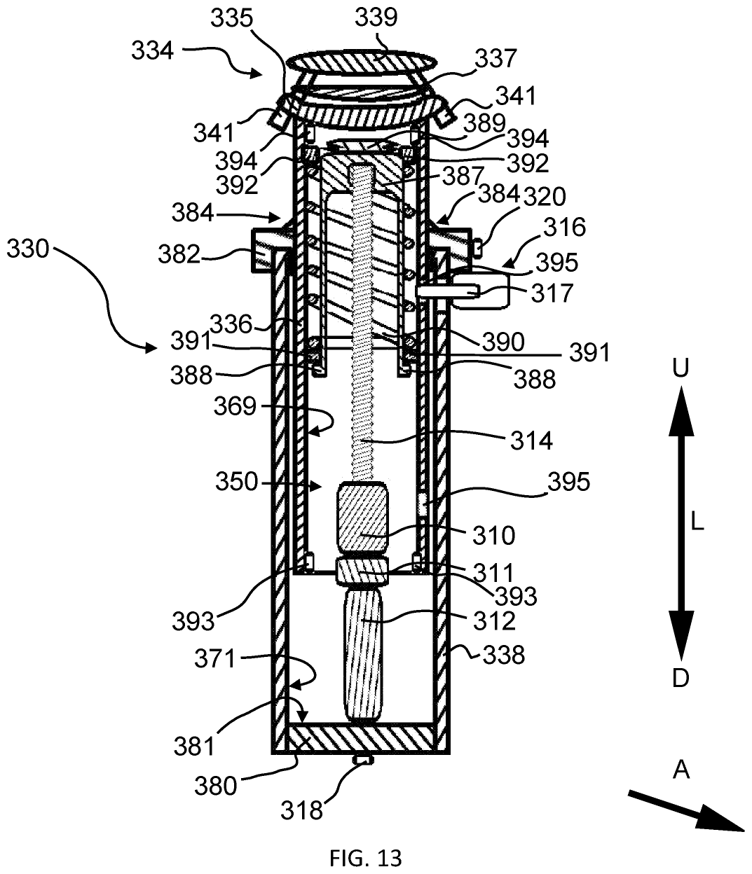

Continuing to FIG. 12, once this lowered and unloaded state is achieved (or while the upper post 336 is moving towards the lowered position), the locking assembly 316 may again lock (or prepare to lock), for example automatically, and the motor 310 may again operate to return to a preloaded state, for example automatically. To achieve the lowered and preloaded state shown in FIG. 13 from the lowered and unloaded state shown in FIG. 12, the motor 310 is operable to drive the carrier 387 in the upward direction U along the longitudinal travel path L through operation of the output shaft 314. The carrier stop(s) 388 drive the energy storage device lower carrier 391 in the upward direction U, thus loading the energy storage device 390 as the energy storage device upper carrier 392 is constrained against the energy storage device upper stop(s) and the locked upper post 336. From this preloaded and lowered state, a command may be given to unlock the upper post 336 with the locking assembly 316, sending the adjustable seatpost assembly 330 to the raised and unloaded state shown in FIG. 10. As such, the adjustable seatpost assembly 330 can toggle between its raised and lowered positions with automatic preloading operations achieved therebetween. In some instances, the adjustable seatpost assembly 330 may be lockable in one or more intermediate positions between the raised and lowered positions, for example using an intermediate locking passage 395.

As shown in FIG. 13, the tension device 389 may be freely compressible to facilitate travel of the carrier 387 as needed. For example, the tension device 389 may be conceptualized as a cord or string, with strength in tension but flexibility in compression. In an embodiment, the tension device 389 may be configured as a collapsible bellows. The tension device 389 in such a bellows configuration may include one or more reinforcement cords, for example made out of a strong tensile material. Such a bellows configuration of the tension device 389 may additionally or alternatively include discrete tensile cords housed inside the tension device 389.

Turning now to FIG. 14, a schematic sectional view of an adjustable seatpost assembly 430 is shown in an extended position and unloaded state. The adjustable seatpost assembly 430 of FIG. 14 depicts a height change assembly 450 that is both drivable and loadable or pre-loadable, for example as described with reference to FIGS. 10-13 above. As in other embodiments, a lower post 438 is configured to mount to a bicycle frame and an upper post 436 includes a saddle support structure 434. The saddle support structure 434 is generally configured to accept a bicycle seat or saddle and control its relative position to the upper post 436. As shown, the saddle support structure 434 includes a saddle reference structure 435 fixed relative to the upper post 436. For example, the saddle reference structure 435 may be integral to the upper post 436 and used to define a relationship between the attached saddle and the adjustable seatpost assembly 430. Beyond the saddle reference structure 435, a lower saddle clamp 437 and an upper saddle clamp 439 may be provided and fastened with one or more of a saddle clamp fastener 441. This arrangement may be used to finely adjust and fix a desired angle and/or fore-aft position of the saddle (not shown) relative to the adjustable seatpost assembly 436, for example by clamping to a set of saddle rails (not shown) fixed to the saddle (not shown).

In FIG. 14, the height change assembly 450 is mounted or mountable on a bottom cap 480, and specifically to a bottom cap inside surface 481. The bottom cap 480 may be removable, for example threadably removable, to facilitate assembly, disassembly, and/or service. The height change assembly 450 shown may also be spaced apart from a lower post inner surface 471 of the lower post 438 and from an upper post inner surface 469 of the upper post 436. This spaced apart configuration facilitates movement of the upper post 436 between at least a portion of the height change assembly 450 and the lower post inner surface 471 of the lower post 438 throughout the travel of the upper post 436. As shown, the bottom cap 480 may provide control of one or more communication or transmission structures from an actuation device (not shown). Operation of the height change assembly 450 results in a driving force acting on the saddle support structure 434 through the upper post 436 in the upward direction U or the downward direction D along the longitudinal travel path L. The upper post 436 may be constrained along the longitudinal travel path L between upper and lower positions, for example by stop features provided on the lower post 438 and/or an endcap 482. A sealing arrangement, for example as described above with reference to FIGS. 3-6 and 10-13 may be provided as a post seal assembly 484, which may further be connected to or integrated with the endcap 482.

Still referring to FIG. 14, the height change assembly 450 is depicted as a motorized height change assembly. Accordingly, the height change assembly 450 includes a motor 410 controlled by a motor controller 411 and powered by a motor power source 412. The motor 410 is operable to drive an output shaft 414. The output shaft 414 is configurable to provide driving force to the adjustable seatpost assembly 430 through various structures. As shown in FIG. 14, the output shaft 414 is configured to drive a carrier 487. The carrier 487 as shown is operable to drive the upper post 436 relative to the lower post 438. As described in greater detail below, the carrier 487 may be configured to drive an energy storage device 490 which in turn may selectively drive the upper post 436 upwards and downwards. Selective control of the energy storage device 490 may be achieved with a locking assembly 416. As shown, the locking assembly 416 includes at least one locking feature 417 operable to lock the upper post 436 relative to the lower post 438. As such, the locking assembly 416 facilitates preloading of the adjustable seatpost assembly 430 with the energy storage device 490 and releasing of preloaded energy from the energy storage device 490 with operation of the locking assembly 416. As shown, the locking assembly 416 is configured to interact with one or more locking passages 495. For example, the locking feature 417 may be sized and shaped to selectively insert into and retract from a first set of the locking passages 495 to lock the adjustable seatpost assembly 430 in the extended position and a second set of the locking passages 495 to lock the adjustable seatpost assembly 430 in the retracted position.

Communication to the height change assembly 450 may be effected through one or more communication features. As shown in FIG. 14, an internal communication feature 418 may be provided on the lower post 438 for internal or stealth routing and/or an external communication feature 420 may be provided on the upper post 436, an upper portion of the lower post 438, or the endcap 482 as shown. The communication features 418, 420 may generally accept routing of electrical conductors to send and/or receive signals and/or power between the adjustable seatpost assembly 430 and another component such as an actuation assembly shown in FIGS. 19A and 19b.

As will be discussed in greater detail below with reference to FIGS. 14-17 and as generally described above with reference to FIGS. 10-13, the motor 410 is configured to impart a driving force on the energy storage device 490 through the carrier 487 and a tension device 489. The carrier 487 may facilitate driving energy into the energy storage device 490 for release in the upward direction U and the tension device 489 may facilitate driving energy into the energy storage device in the downward direction D. As shown in FIG. 14 with the energy storage device 490 in an unloaded state, an energy storage device lower carrier 491 maintains the energy storage device 490 above an energy storage device lower stop 493 fixed to the lower post 438. Similarly, an energy storage device upper carrier 492 maintains the energy storage device below an energy storage device upper carrier 492.

It should be appreciated that while the state in FIG. 14 is herein referred to as an unloaded state, the energy storage device 490 may still be under load. For example, a four-bar spring embodiment of the energy storage device 490 may be preloaded in this unloaded state between the energy storage device lower stop 493 and the energy storage device upper stop 494 while still not being actively loaded through operation of the motor 410. Generally speaking, driving operation of the carrier 487 in the upward direction U drives a carrier stop 488 upwards into the energy storage device lower carrier 491 to move it off of the energy storage device lower stop 493 to store energy for a lifting operation. Driving operation of the tension device 489 in the downward direction D drives the energy storage device upper carrier 492 downwards to move it off of the energy storage device upper stop 494 to store energy for a lowering operation. As discussed in greater detail below, the tension device 489 and the carrier 492 are configured so as to not interfere with the driving operation of the other.

The embodiment of FIGS. 14-17 further includes a travel clearance 496 configured to facilitate travel of the upper seatpost 436. As shown, the travel clearance 496 may be sized and shaped to allow easy travel of the upper seatpost 436 through its intermediate positions. In an embodiment, the travel clearance 496 is an integral recess to the lower post inner surface 471. The travel clearance 496 is configured to not interfere with a stable lockup in the raised and lowered positions of the upper seatpost 436 while still facilitating a reduction in energy to move between the raised and lower positions. Although not shown in FIGS. 14-17, the upper seatpost 436 may be configured with one or more corresponding travel features, such as wedge features, sized and shaped to interface with the travel clearance 496. Such corresponding travel features could aid in lockup in the raised and lowered positions, for example by wedging into the upper and lower extreme portions of the travel clearance 496.

As shown in FIG. 14, the locking feature 417 of the locking assembly 416 may be controlled at least in part by the height change assembly 450. Specifically, operation of the motor 410 may control unlocking and/or locking of the locking assembly 416. In FIG. 14, The locking assembly 416 is shown in a locked state with the locking features 417 extending through the locking passages 495 and locking the upper post 436 to the lower post 438. As shown, the locking features 417 may be biased (i.e. spring loaded) towards this position as a default position. Such a configuration may be used to ensure a lock-safe operation. Although not shown in FIGS. 14-17, further locking passages 495 may be provided corresponding to one or more intermediate positions between the raised and lowered positions, for example an intermediate safety catch position.

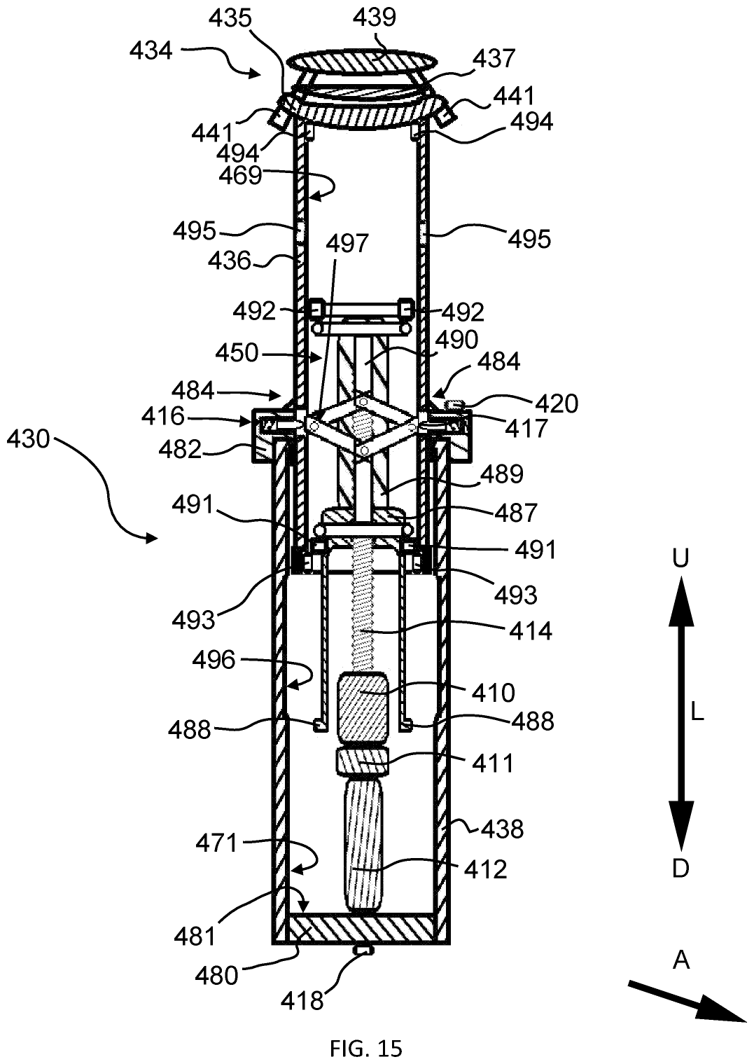

As shown in moving from FIG. 14 to FIG. 15, downward driving of the tension device 489 may move one or more of an unlocking feature 497 into contact with the locking feature(s) 417. The unlocking features 497 shown in FIGS. 14-17 may be integrated with or in addition to the energy storage device 490. For example, the four-bar linkage configuration shown may be internally biased or sprung to act as an energy storage device 490 generally similar to that described with reference to FIGS. 10-13 above. Alternatively, the unlocking features 497 may be provided as shown or with another configuration, in conjunction with an energy storage device 390 as described with reference to FIGS. 10-13 above.

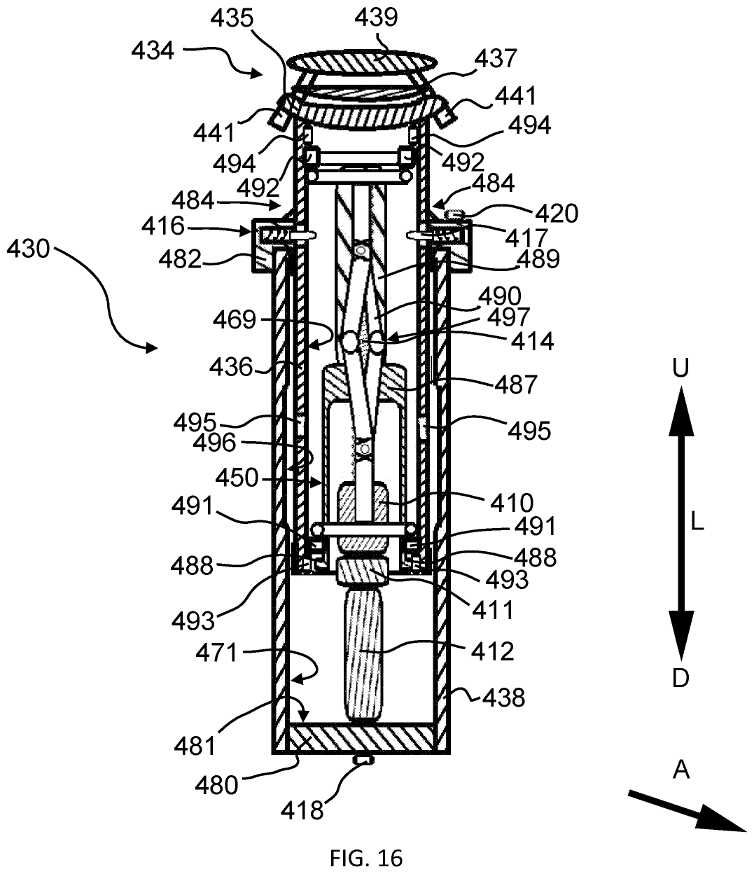

Returning to FIG. 15, the state shown here may be described as a raised and preloaded state that has just been unlocked. It should be appreciated that the motor 410 may be controlled to automatically preload the energy storage device 490 to a point just prior to unlocking, such that an unlock command from a rider need only slightly add additional force to the energy storage device 490 to achieve unlocking and thus driving of the upper post downward to the lowered and unloaded state shown in FIG. 16.

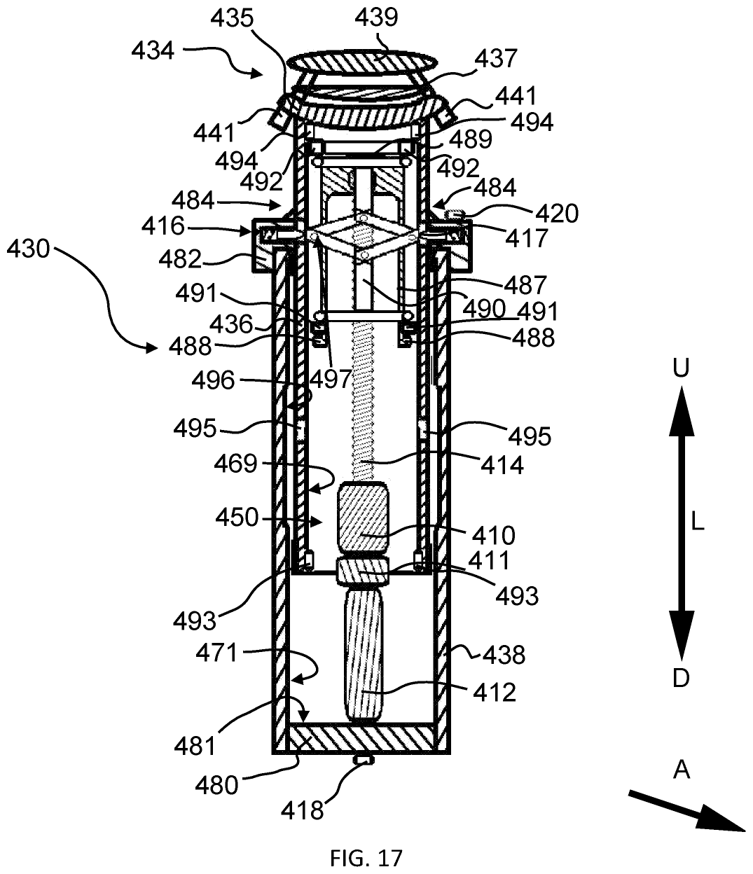

Turning to FIG. 16, the state shown has been automatically locked by sprung action of the locking assembly 416. As described above, the motor may automatically preload the energy storage device 490 with the carrier 487 moving in the upward direction U. Such preloading may be automatically stopped prior to full travel of the carrier 487, thus not unlocking the locking assembly 416. A user input may then be awaited, upon receipt of which full travel of the carrier 487 may be achieved with the motor 410, slightly increasing preload and unlocking the locking assembly 416, as shown in the instant state of FIG. 17 to then return to the state shown in FIG. 14.

Turning now to FIG. 18a, a schematic view of a mechanical actuation assembly 710 is provided. The actuation assembly 710 shown is mountable to a handlebar 725, for example about a handlebar axis H with a handlebar clamp 767. As shown, the mechanical actuation assembly 710 includes an actuator 712 for user operation, shown here in a lever configuration. The actuator 712 includes a user interface 768, for example a thumb paddle, configured to receive a user input. In FIG. 18a, the actuator 712 is shown in a first position or a rest position while in FIG. 18b the actuator 712 is shown in a second position or an actuated position. As described above with reference to FIGS. 3-6, actuation of a cable 758 may in turn operate a height change mechanism as discussed with reference to those embodiments. As shown in FIGS. 18A and 18b, the cable 758 may generally be described as part of a Bowden cable system. Specifically, the cable 758 is received in the actuation assembly 710 through an actuator housing stop 762 and a cable guide 759. The actuator housing stop 762 is operable to receive a cable housing 760, for example the same cable housing used in one of the embodiments of FIGS. 3-6.

Referring still to FIGS. 18A and 18b, the cable 758 may be controlled relative to the actuator housing stop 762 mounted to an actuator body 761. By controlling the length of the cable 758 between the actuator housing stop 762 and a cable fastener 765, a length on the other end of the cable housing 760, for example at a height change assembly, may in turn be controlled. Operation of the actuator 712 increases the effective length of the cable 758 between the actuator housing stop 762 and the cable fastener 765 by the difference shown in the first cable wrap distance B (FIG. 18a) and the second cable wrap distance BB (FIG. 18b). The change in cable wrap distance is effected by an actuator pulley 763 rotatable about an actuation axis and fixed with a pulley fastener 764.

As described above with reference to FIGS. 18a and 18b, the actuator 712 is movable between at least its rest position and its actuated position. When viewed in combination with the embodiments of the height change assembly in FIGS. 3-6, it should be appreciated that movement of the actuator 712 from the rest position to the actuated position may thus operate a height change mechanism to drive an adjustable seatpost assembly from its retracted position to its extended position and from its extended position to its retracted position. As described above, the actuator 712 thus transmits a mechanical force to an associated height change assembly, which in turn transmits a mechanical force to a seatpost.

FIGS. 19a and 19b show schematic views of an electrical actuation assembly 810. As shown in FIGS. 19a and 19b, the electrical actuation assembly 810 generally includes an actuator 812 and an actuator body 861, where the actuator 812 is movable relative to the actuator body 861. The actuator body 861 is mountable to a bicycle, for example to a handlebar assembly (not shown) by clamping an actuator first body portion 862 to an actuator second body portion 863 about a handlebar axis H with an actuator fastener 867. Operation of the actuator 812 may be performed by a user or rider with the user interface 868, for example in a thumb paddle configuration. It should be appreciated that the actuation assembly 810 described herein is exemplary and may include any number of variations of buttons, levers, or switches operable to transmit a user input.

Between FIGS. 19a and 19b, the actuator 812 is movable between the rest position in FIG. 19a and the actuated position in 19b. Movement to the actuated position may be operable to transmit a user input signal, for example to a height change assembly as described above. Such a user input signal may be operable to toggle between extended and retracted positions of such a height change assembly. In an embodiment, further actuators (not shown) may be provided, for example to discretely control upward movement and downward movement and/or to operate a preloading function, for example as discussed with reference to FIGS. 10-17. As shown, it should be appreciated that such a preloading function may be automatic, facilitating simple use of the actuator to generate an input signal. In an embodiment, such an input signal would trigger driving of a seatpost to an upper position from a lower position or from the lower position to the upper position, depending on the position from which the seatpost starts.

Still referring to FIGS. 19a and 19b, the first position shown in FIG. 19a may be described with reference to a reference line R generally aligned with the longitudinal travel path L. The rest position shown in FIG. 19a is defined with a first position reference R1 relative to this reference line R and passing through the actuator 812. The actuated position shown in FIG. 19b is defined with a second position reference R2 relative to the reference line R and similarly passing through the actuator 812. As shown between these depictions, the second reference position defines a second angle A2 with the reference line R which is greater than a first angle A1 defined with the first position reference R1 and the reference line R. The difference in the first angle A1 and the second angle A2 defines an actuation angle. Relative to the mechanical actuation assembly 710, the actuation angle of the electrical actuation assembly 810 described herein may be relatively small, facilitating easy operation.

As shown in FIGS. 19a and 19b, an actuator power source 814 may be provided. Additionally or alternatively, the actuation assembly 810 may use power from another source, such as a power source as described with reference to FIGS. 10-17 above. A power source could be integrated with another component such as a propulsion power source in an e-bike. Additionally or alternatively, the actuation assembly 810 or other components could draw power from a generator such as a dynamo driven by a wheel or another component. It should be appreciated that a single power source may be used for multiple components or that multiple power sources may provide redundancy for a single component.

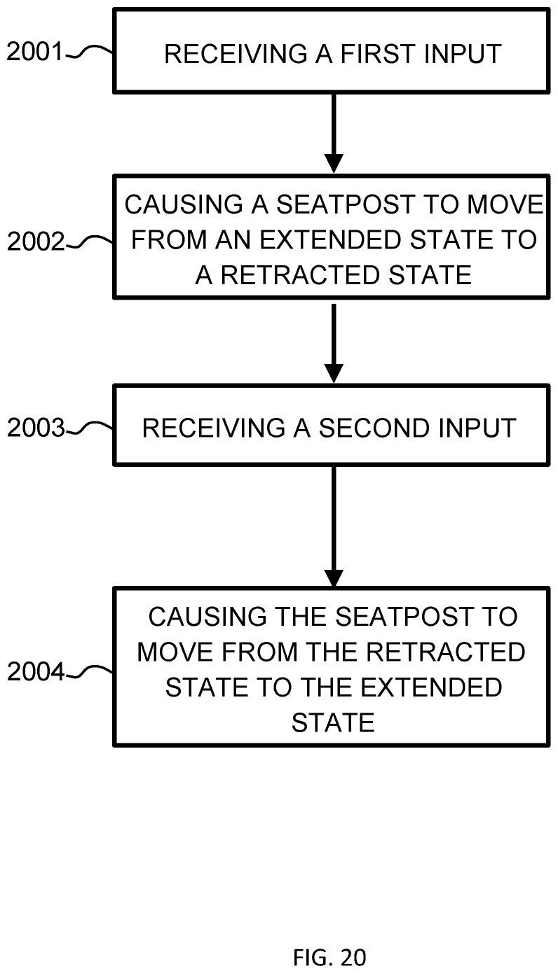

Turning now to FIG. 20, a flow chart depicts a method of positioning a seatpost between a plurality of states. The method described herein generally includes receiving a first input (2001). In (2001), the receiving may be performed by a height change assembly of the seatpost, for example at a motor controller of a height change assembly as described above with reference to FIGS. 10-17. It should also be appreciated that the receiving may be performed by a mechanical component of a height change assembly, for example a driving wheel as described with reference to FIGS. 3-9. The method further includes causing the seatpost to move from an extended state to a retracted state (2002). In (2002), the seatpost may be moved by any embodiment of a height change assembly as described herein above, for example a mechanical, electrical, or electromechanical embodiment of a height change assembly. This operation (2002) generally is responsive to receiving the first input at (2001). The method further includes receiving a second input (2003). As with receiving the first input (2001), receiving the second input (2003) is generally downstream of an actuation assembly. For example, a mechanical or electrical actuation assembly may transmit a force or signal to be received in (2003). The method further includes causing the seatpost to move from the retracted state to the extended state (2004). This operation (2004) generally is responsive to receiving the second input at (2003). In (2004), the seatpost may be moved by any embodiment of a height change assembly as described herein above, for example a mechanical, electrical, or electromechanical embodiment of a height change assembly.

The method of FIG. 20 may further include features such as locking, with a locking assembly, the seatpost in the extended state. For example a discrete locking assembly may actively lock the seatpost or the seatpost may be locked with an automatically-locking arrangement, each as generally described above with reference to the various embodiments. Locking may additionally or alternatively be achieved in the retracted state of the seatpost in similar manners. It should also be appreciated that different locking assemblies and/or members may be used to lock in the extended and retracted states.

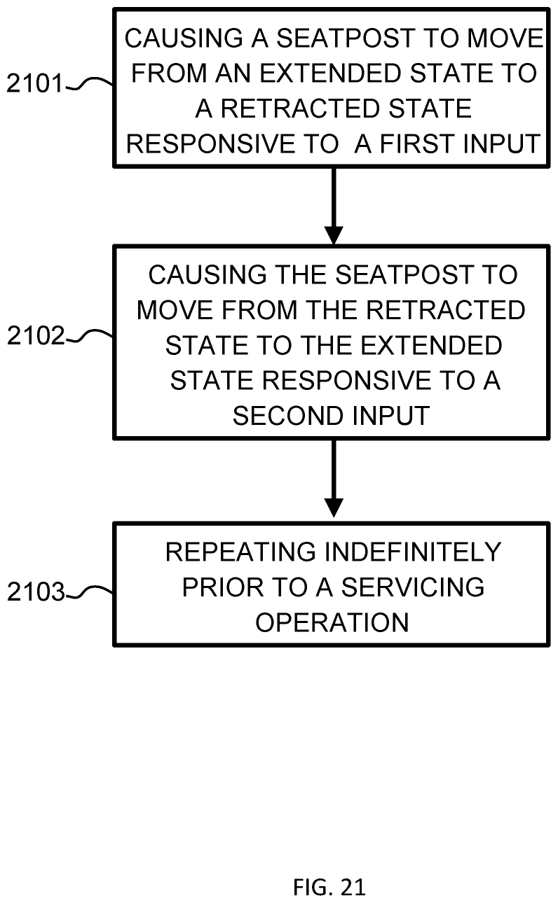

Turning now to FIG. 21, a flow chart depicts a method of configuring a seatpost assembly between a plurality of states. The method described herein generally includes causing the seatpost to move from an extended state to a retracted state responsive to a first input (2101). In (2101), a height change assembly as generally described above may be operable to move the seatpost responsive to the first input. The method further includes causing the seatpost to move from the retracted state to the extended state responsive to a second input (2102). In (2102), the same height change assembly as in (2101) may generally be employed. The second input in (2102) may be the same or different to the first input in (2101). For example, the first input and the second input may be the same electrical input (i.e. a same button press) or the same mechanical input (i.e. a cable pull). The method may be repeated indefinitely prior to a servicing operation (2103). In (2103), the method may be repeated any number of times, but specifically is not dependent on energy discharge to determine an amount of repeatability. For example, (2103) may be achieved by using a mechanical input from a user or through generator or dynamo arrangement with an electrical system. It should be appreciated that (2103) may be further expanded and defined by facilitating that the seatpost is movable by the height change assembly between the extended state and the retracted state at least 100, 200, 500, 1000, or 10,000 times prior to the servicing operation.

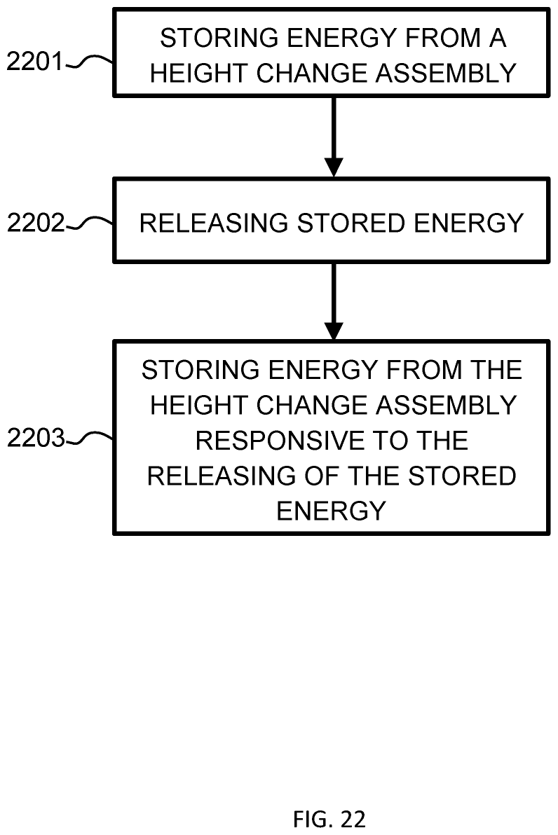

Turning now to FIG. 22, a flow chart depicts a method of positioning a seatpost assembly between a plurality of states. The method described herein generally includes storing energy from a height change assembly (2201). In (2201), the energy may be stored with an energy storage device such as any of those described in relation to FIGS. 10-17. The method further includes releasing stored energy (2202). In (2202), the releasing may be performed with a locking assembly, for example as described with reference to FIGS. 10-17 above. Such release may allow release of the energy stored or preloaded within the energy storage device. The method further includes storing energy from the height change assembly responsive to the releasing of the stored energy (2203). That is, in (2203), energy is stored responsive to the release in (2202). As described with reference to FIGS. 10-17 above, (2203) may be achieved automatically as a preloading function of the energy storage device.

Still referring to FIG. 22, the method described herein may further include locking, with a locking assembly, the seatpost in an extended position responsive to the releasing of (2202). Such locking may facilitate reloading/preloading of the energy storage device as described with reference to FIGS. 10-17 above. Furthermore, one or more sensors, such as those described above and including motor sensors such as in a stepper motor, or sensors integral to a motor controller may be provided. For example, a sensor may be used to detect energy stored with the energy storage device. This detection may be achieved directly or indirectly, for example through motor force detection and calculation using known properties of the energy storage device (i.e. spring constant, preload force, etc.). A processor, such as in a motor controller, may then be used to determine if the energy storage device has achieved a threshold. For example, the processor may detect if the energy storage device has sufficient energy to reach a next actuation position (i.e. an extended position or a retracted position). The threshold may be predetermined and may be variable, for example based on past detections of complete or incomplete actuation or of environmental conditions such as temperature or contamination. If the processor determines that the threshold has been achieved, the processor may proceed to generating a ready signal. This ready signal may be displayed to a rider, for example through a light or audio indicator. If the processor determines that the threshold has not been achieved, the processor may refuse releasing (i.e. not send an actuation signal responsive to a user input) the energy stored in the energy storage device.

Terms such as “processor” and “motor controller” as used herein can include any suitable processing device (e.g., a control circuitry, a processor core, a microprocessor, an application specific integrated circuit, a field programmable gate array, a controller, a microcontroller, etc.) and can be one processor or a plurality of processors that are operatively connected. The processor can be in communication with a memory. The memory can include one or more non-transitory computer-readable storage media, such as RAM, ROM, EEPROM, EPROM, one or more memory devices, flash memory devices, etc., and combinations thereof. The memory can store information that can be accessed by the processor(s). For instance, the memory (e.g., one or more non-transitory computer-readable storage mediums, memory devices) can include computer-readable instructions that can be executed by the processor(s). The instructions can be software, firmware, or both written in any suitable programming language or can be implemented in firmware or hardware. Additionally or alternatively, the instructions can be executed in logically and/or virtually separate threads on processor(s). For example, the memory can store instructions that when executed by the processor(s) cause the processor(s) to perform operations such as any of the operations and functions as described herein.

The processor(s) may be in communication with a remote server, for example via an onboard wireless communication device, such as a transceiver. The wireless communication device can wirelessly communicate using any reliable method including, for example, WiFi, WIMAX, LTR, BLUETOOTH, or other proprietary or public wireless communication methods. The remote server can transmit instructions to the processor(s) that cause performance of one or more operations. For example, the remote server can cause the processor(s) to update the instructions stored in memory. The remote server may also communicate with the processor(s) to detect, and optionally adjust, performance of the adjustable seatpost assembly. In some instances, the remote server can store information associated with the adjustable seatpost assembly. For example, the remote server can store information relating to system health, battery life, motor performance, use frequency, etc., for example, to provide better user experience.

In an embodiment, the adjustable seatpost assembly may be controllable and/or tunable by a mobile computing device (such as a smartphone, tablet, or laptop). The remote server and/or processor(s) of the adjustable seatpost assembly may communicate with the mobile computing device. The rider can access information associated with the adjustable seatpost assembly from the mobile computing device and/or adjust one or more settings of the adjustable seatpost assembly using the mobile computing device. For instance, the mobile computing device can include an application that interfaces with the adjustable seatpost assembly (directly or indirectly, e.g., through the remote server). The rider can tune the adjustable seatpost assembly using the application associated with the mobile computing device. For example, in motorized embodiments, the user may adjust between a maximum performance mode and a battery saving mode, or even adjust preload settings and/or locking characteristics. In maximum performance mode, the motor may operate at higher power outputs, allowing for faster preload. Conversely, in battery saving mode, the motor may operate at lower power outputs with slower preload capability but prolonged operational use. Yet other variably adjustable configurations and characteristics may be selectively tuned by the rider prior to or during a ride. The rider may toggle between modes in view of terrain, ride duration, remaining charge, or the like. In some instances, the adjustable seatpost assembly may include a user interface, such as one or more buttons or toggles, through which the rider can interact with the motor controller. For example, the rider may toggle between different operational modes, or even lockout the adjustable seatpost assembly on demand. In some embodiments, the rider may enter an autonomous (or semi-autonomous) mode whereby the motor controller adjusts saddle height using predictive analysis based on riding data (e.g. accelerometer terrain data). In other instances, the rider may rely on a manual control mode, e.g., using the actuation assembly.

In an embodiment, the rider may access information regarding the adjustable seatpost assembly, e.g., using the remote computing device. For example, the memory of the motor controller can store information associated with the adjustable seatpost assembly. The information can be communicated to the remote computing device to be accessed by the rider. Certain information can be geolocated, or tagged, with coordinates (or other location discerning information) where an action occurred. For example, the rider may be able to access a map upon which information associated with actuation of the adjustable seatpost assembly is overlaid. This actuation information may allow the rider to review their ride or even update instructions for use of the adjustable seatpost assembly for future rides. For example, the rider may cause the adjustable seatpost assembly to actuate similarly, or the same, on future rides, by saving and implementing actuation information associated with one or more previous rides. The rider may also adjust the information for the future ride based on review of the previous ride(s) (e.g., to actuate the adjustable seatpost assembly sooner at technical parts of the travel environment). In this regard, use of the adjustable seatpost assembly may also be hands free when the user has already input instructions for actuation. It should be understood that the rider may also input instructions for actuations ahead of riding a trail for the first time. For example, the rider can select one or more locations along a trail using the mobile computing device. The rider can associate these one or more locations with actuation of the adjustable seatpost assembly such that the adjustable seatpost assembly automatically actuates when the location of the bicycle is detected at the one or more locations. Of course, the rider can further implement control of the adjustable seatpost assembly using the actuation assembly.

The motor power source may have a finite energy storage capacity, limiting use of the adjustable seatpost assembly to a predefined number of actuations (i.e., between the raised and lower positions). To avoid range anxiety, a user notification device may be provided to notify the rider of remaining actuation capacity. The user notification device can include a digital display, such as an LCD, LED, or OLED screen; an analog display, such as a physical dial, a speaker or other audible notification system, or the like. The user notification device can provide the rider with information associated with remaining actuation capacity. For example, the user notification device can provide an estimated number of remaining actuations prior to depletion of energy at the motor power source, a percentage of remaining charge at the motor power source, a color indicative of remaining charge (e.g., dark green for full charge, dark red for empty, and other color(s) therebetween to indicate intermediate charge levels), or the like. In an embodiment, the user notification device can generate a user warning (e.g., a tactile warning, an audible warning, a visual warning, etc.) when the remaining charge at the motor power source falls below a predetermined threshold. This predetermined threshold may be adjustable, such as for example, at the application executed by the mobile computing device. For implementations where the motor power source is charged in situ, the user notification device can further provide information associated with remaining charge time, system health, or the like during charging. The user notification device can be positioned at a location along the bicycle where the rider can easily detect the provided information. For example, the user notification device can be coupled to the handlebar (for example, at the actuation assembly) or at a stem of the bicycle. The user notification device may be powered by a separate power source, the actuator power source, the motor power source, an onboard power source (in the case of an e-bike), or a combination thereof.

The motor power source may, from time to time, deplete before the rider completes a ride (particularly when the rider forgets to recharge the motor power source after a previous ride). In such instances, the adjustable seatpost assembly may be reconfigurable to a non-actuatable mode where the rider can manually adjust saddle height and lock the adjustable seatpost assembly in the adjusted saddle height. In an embodiment, the non-actuatable mode may be entered into even when the motor power source has sufficient remaining charge to actuate the adjustable seatpost assembly by the user manually moving the upper post of the adjustable seatpost assembly.

Some riders prefer the use of saddle bags that attach to structural aspects of the seatpost or saddle. Embodiments described herein may physically accommodate the use of such saddle bags. Moreover, embodiments described herein may allow the rider to tune the adjustable seatpost assembly to counteract the effects of gravity on the saddle bag and restore neutral buoyancy to the adjustable seatpost assembly. For example, the rider can add a biasing element, like a coil or torsional spring, that biases the adjustable seatpost assembly to the raised position to overcome downward force from the saddle bag.

It should be understood that adjustable seatpost assemblies in accordance with some embodiments herein may be stored with preloaded energy when the bicycle is not actively in use. Storage of preload may prematurely wear or exhaust components of the adjustable seatpost assembly. Accordingly, the adjustable seatpost assembly (e.g., processor(s) associated with the adjustable seatpost assembly) may be configured to release stored energy under certain conditions, such as when the bicycle is detected in a stationary position for a predetermined duration of time. The rider can select the predetermined duration of time, or even disengage the automatic release of stored energy, for example using the mobile computing device. In an embodiment, release of stored energy may be gradual to prevent the seatpost from moving from an existing position to another position. For example, the motor controller may release preload by gradually unloading energy stored in the energy storage device. The motor controller can store instructions which, when executed, cause the motor to perform this gradual unloading to reconfigure the adjustable seatpost assembly to the unloaded position.

The adjustable seatpost assemblies and other assemblies described herein may be provided with any of the features and elements as shown and described. The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Further aspects of the disclosure are provided by one or more of the following embodiments:

Embodiment 1. A seatpost assembly comprising: a lower post; an upper post movable relative to the lower post between a high position and a low position; an actuation assembly configured to receive a user input; and a height change assembly operable to drive the upper post to the high position responsive to receiving the user input and to drive the upper post to the low position responsive to receiving the user input.

Embodiment 2. The seatpost assembly of embodiment 1, wherein the actuation assembly comprises an input device, and wherein the user input is generated by operating the input device.

Embodiment 3. The seatpost assembly of embodiment 2, wherein the input device comprises a mechanical lever.

Embodiment 4. The seatpost assembly of embodiment 2, wherein the input device comprises an electrical switch.

Embodiment 5. The seatpost assembly of any one or more of embodiments 1 to 4, wherein the user input is the same to drive the upper post to the high position and to drive the upper post to the lower position.

Embodiment 6. The seatpost assembly of any one or more of embodiments 1 to 5, wherein the actuation assembly is configured to transmit an actuation signal responsive to the user input, wherein the height change assembly is configured to receive the actuation signal, and wherein the height change assembly is configured to toggle between the high position and the low position responsive to receiving the actuation signal.

Embodiment 7. The seatpost assembly of any one or more of embodiments 1 to 6, wherein the upper post comprises a saddle support structure sized and shaped to receive a saddle, and wherein the saddle support structure is movable relative to the lower post with the upper post at the high position.

Embodiment 8. The seatpost assembly of embodiment 7, wherein the saddle support structure is movable relative to the lower post with the upper post at the low position.

Embodiment 9. The seatpost assembly of embodiment 7, wherein the saddle support structure is movable relative to the lower post in a direction along an axial length of the upper post.

Embodiment 10. The seatpost assembly of any one or more of embodiments 1 to 9, further comprising a locking assembly configured to lock the upper post at the high position.

Embodiment 11. The seatpost assembly of embodiment 10, wherein the locking assembly is further configured to lock the upper post at the low position.

Embodiment 12. The seatpost assembly of embodiment 10, wherein the locking assembly comprises a first locking structure configured to selectively lock the upper post at the high position, and wherein the locking assembly comprises a second locking structure configured to selectively lock the upper post at the low position.

Embodiment 13. The seatpost assembly of embodiment 10, wherein the locking assembly, responsive to receiving a locking input, toggles the locking assembly between a locked state and an unlocked state.

Embodiment 14. The seatpost assembly of embodiment 13, wherein the locking input is generated by the user input.

Embodiment 15. The seatpost assembly of any one or more of embodiments 1 to 14, wherein the height change assembly comprises: a first arm coupled to the upper post; and a second arm coupled to the lower post.

Embodiment 16. The seatpost assembly of embodiment 15, further comprising a spring biasing the first and second arms relative to one another.

Embodiment 17. The seatpost assembly of embodiment 16, wherein the first and second arms are rotatably coupled together at a rotational axis, and wherein the spring rotatably biases the first and second arms relative to one another at the rotational axis.

Embodiment 18. The seatpost assembly of embodiment 15, wherein the first arm is rotatably coupled to the second arm about a rotational axis.

Embodiment 19. The seatpost assembly of embodiment 18, wherein the rotational axis is oriented orthogonally to a longitudinal axis of the lower post.

Embodiment 20. The seatpost assembly of embodiment 15, wherein the first arm is configured to rotate relative to the upper post responsive to rotation of the second arm relative to the lower post.

Embodiment 21. The seatpost assembly of embodiment 15, further comprising a third arm rotatably coupled to at least one of the first arm or the second arm, the third arm rotatable responsive to rotation of the second arm relative to the lower post.

Embodiment 22. The seatpost assembly of embodiment 15, wherein the first arm is disposed at a first angle, as measured with respect to a longitudinal axis of the lower post, when the upper post is at the high position, wherein the first arm is disposed at a second angle, as measured with respect to the longitudinal axis, when the upper post is at the low position, and wherein the first and second angles are different from one another.

Embodiment 23. The seatpost assembly of embodiment 22, wherein the first angle is less than the second angle.

Embodiment 24. The seatpost assembly of embodiment 15, wherein the height change assembly further comprises a rotatable element rotatably driven responsive to the user input, and wherein the second arm is operably coupled to the rotatable element such that the height change assembly drives the upper post responsive to rotation of the rotatable element.

Embodiment 25. The seatpost assembly of embodiment 24, wherein the rotatable element comprises a motor shaft.

Embodiment 26. The seatpost assembly of embodiment 24, wherein receipt of the user input by the actuation assembly causes displacement of a cable, and wherein the cable is mechanically coupled to the rotatable element.

Embodiment 27. The seatpost assembly of embodiment 24, wherein the rotatable element comprises a first stop feature and a second stop feature, wherein the second arm is engaged with the first stop feature when the upper post is in the high position, and wherein the second arm is engaged with the second stop feature when the upper post is in the low position.

Embodiment 28. The seatpost assembly of embodiment 27, wherein the first and second stop features are operably coupled together by a surface, and wherein an interfacing portion of the second arm is configured to translate along the surface to move between the first and second stop features.

Embodiment 29. The seatpost assembly of embodiment 15, wherein the first and second arms are coupled together by a plurality of intermediate arms.

Embodiment 30. The seatpost assembly of embodiment 29, wherein the plurality of intermediate arms are arranged in sets, each set including two of the plurality of intermediate arms, and wherein the sets together form a scissor linkage.

Embodiment 31. The seatpost assembly of embodiment 29, wherein each of the plurality of intermediate arms is identical.

Embodiment 32. The seatpost assembly of any one or more of embodiments 1 to 31, wherein the height change assembly is essentially free of a pressure vessel.

Embodiment 33. The seatpost assembly of any one or more of embodiments 1 to 32, wherein the upper post is movable by the height change assembly from the high position to the low position indefinitely prior to a servicing operation.

Embodiment 34. The seatpost assembly of any one or more of embodiments 1 to 33, wherein the height change assembly is disposed entirely within a volume defined by the upper and lower posts.

Embodiment 35. The seatpost assembly of any one or more of embodiments 1 to 34, wherein the upper post has a first cross-sectional shape, wherein the lower post has a second cross-sectional shape, and wherein the first and second cross-sectional shapes are different from one another.

Embodiment 36. The seatpost assembly of any one or more of embodiments 1 to 35, wherein the lower post has a non-circular cross-sectional shape.

Embodiment 37. The seatpost assembly of any one or more of embodiments 1 to 36, wherein the upper post is configured to receive a saddle, and wherein an angle of the saddle, as measured with respect to a longitudinal axis of the lower post, is the same with the upper post in the high position and the low position.

Embodiment 38. The seatpost assembly of any one or more of embodiments 1 to 37, wherein the actuation assembly is configured to wirelessly transmit a signal responsive to the user input.

Embodiment 39. The seatpost assembly of any one or more of embodiments 1 to 38, further comprising a clutch operably disposed between the actuation assembly and the height change assembly, wherein the clutch is configured to slip at a threshold condition.

Embodiment 40. The seatpost assembly of embodiment 39, wherein the threshold condition is defined at least in part by a threshold force.

Embodiment 41. The seatpost assembly of any one or more of embodiments 1 to 40, wherein the actuation assembly is coupled to the height change assembly by a cable, and wherein the seatpost assembly comprises a plurality of cable routing pathways, each of the plurality of cable routing pathways defining a different route for routing the cable between the actuation assembly and the height change assembly.

Embodiment 42. The seatpost assembly of any one or more of embodiments 1 to 41, wherein the height change assembly is directly driven by the actuation assembly.

Embodiment 43. The seatpost assembly of any one or more of embodiments 1 to 42, wherein the user input received at the actuation assembly has a first force profile, wherein the user input causes the height change assembly to have a second force profile, and wherein the first force profile and the second force profile have a fixed relationship relative to one another.

Embodiment 44. The seatpost assembly of any one or more of embodiments 1 to 43, further comprising an endcap removably coupled to the lower post, the endcap configured to restrain movement of the upper post in the high position, wherein the upper post is removable from the lower post directly after uncoupling the endcap from the lower post.

Embodiment 45. The seatpost assembly of embodiment 44, wherein the endcap is threadably coupled to the lower post.

Embodiment 46. The seatpost assembly of embodiment 44, wherein removing the upper post from the lower post causes a disconnection at the height change assembly, the disconnection permitting removal of the upper post from the lower post.

Embodiment 47. The seatpost assembly of any one or more of embodiments 1 to 46, wherein the height change assembly is serviceable when the lower post is disposed in a seat tube of a bicycle.

Embodiment 48. The seatpost assembly of any one or more of embodiments 1 to 47, further comprising a seal, a lubricant, a scraper, a spring, or any combination thereof disposed circumferentially about the upper post.

Embodiment 49. The seatpost assembly of any one or more of embodiments 1 to 48, wherein the height change assembly comprises: a motor having an output shaft to drive the upper post, wherein the output shaft is disposed in the lower post; and a power source electrically coupled to the motor.

Embodiment 50. The seatpost assembly of embodiment 49, wherein the upper post operably supports the power source.

Embodiment 51. The seatpost assembly of any one or more of embodiments 1 to 50, wherein the seatpost assembly is movable to a service position in which an upper access opening of the upper post and a lower access opening of the lower post align and through which at least one connection between the upper post and the lower post is controllable.

Embodiment 52. The seatpost assembly of any one or more of embodiments 1 to 51, wherein the upper post is rotationally keyed to the lower post.

Embodiment 53. The seatpost assembly of any one or more of embodiments 1 to 52, further comprising an energy storage device, the energy storage device operable to: store energy generated by the height change assembly; release stored energy to drive the upper post to the high position responsive to receiving the user input; and release stored energy to drive the upper post to the low position responsive to receiving the user input.

Embodiment 54. The seatpost assembly of embodiment 53, wherein the energy storage device comprises a spring.

Embodiment 55. The seatpost assembly of embodiment 53, wherein the energy storage device comprises: a first energy storage unit configured to store energy from movement of the height change assembly in a first height change direction and operable to release that stored energy to drive the upper post to the high position responsive to receiving the user input; and a second energy storage unit configured to store energy from movement of the height change assembly in a second height change direction, different from the first height change direction, and operable to release that stored energy to drive the upper post to the low position responsive to receiving the user input.

Embodiment 56. The seatpost assembly of embodiment 53, wherein the energy storage device comprises an energy storage unit, wherein the height change assembly is operable to drive the energy storage unit in: a first direction to store a stored lifting energy; and a second direction, different to the first direction, to store a lowering energy; wherein the stored lifting energy is released to drive the upper post to the high position responsive to receiving the user input; and wherein the stored lowering energy is released to drive the upper post to the low position responsive to receiving the user input.

Embodiment 57. The seatpost assembly of embodiment 56, further comprising a locking assembly, wherein release of the stored lifting energy and the stored lowering energy is controlled by the locking assembly.

Embodiment 58. The seatpost assembly of embodiment 57, wherein the locking assembly is controlled at least in part by the height change assembly.

Embodiment 59. The seatpost assembly of embodiment 58, wherein the locking assembly is integrated with the height change assembly.

Embodiment 60. A seatpost assembly comprising: a seatpost comprising an upper post and a lower post, wherein the upper post is moveable relative to the lower post between a retracted position and an extended position; and a height change assembly coupled between the upper post and the lower post; wherein the height change assembly selectively drives the upper post from the extended position to the retracted position; and wherein the height change assembly selectively drives the upper post from the retracted position to the extended position.

Embodiment 61. The seatpost assembly of embodiment 60, further comprising: an actuation assembly, the actuation assembly comprising an actuator operable to cause the height change assembly to selectively drive the upper post: from the extended position to the retracted position; and from the retracted position to the extended position.

Embodiment 62. The seatpost assembly of any one or more of embodiments 60 or 61, further comprising an energy storage device, the energy storage device operable to: store energy generated by the height change assembly; release stored energy to selectively drive the upper post from the retracted position to the extended position; and release stored energy to selectively drive the upper post to the extended position to the retracted position.

Embodiment 63. The seatpost assembly of embodiment 62, wherein the energy storage device comprises a spring.

Embodiment 64. The seatpost assembly of embodiment 62, wherein the energy storage device comprises: a first energy storage unit configured to store energy from movement of the height change assembly in a first height change direction and operable to release that stored energy to selectively drive the upper post to the retracted position to the extended position; and a second energy storage unit configured to store energy from movement of the height change assembly in a second height change direction, different from the first height change direction, and operable to release that stored energy to selectively drive the upper post from the extended position to the retracted position.

Embodiment 65. The seatpost assembly of embodiment 62, wherein the energy storage device comprises an energy storage unit, wherein the height change assembly is operable to drive the energy storage unit in: a first direction to store a stored lifting energy; and a second direction, different to the first direction, to store a lowering energy; wherein the stored lifting energy is released to selectively drive the upper post from the retracted position to the extended position; and wherein the stored lowering energy is released to selectively drive the upper post from the extended position to the retracted position.

Embodiment 66. The seatpost assembly of embodiment 65, further comprising a locking assembly, wherein release of the stored lifting energy and the stored lowering energy is controlled by the locking assembly.

Embodiment 67. The seatpost assembly of embodiment 66, wherein the locking assembly is controlled at least in part by the height change assembly.

Embodiment 68. The seatpost assembly of embodiment 67, wherein the locking assembly is integrated with the height change assembly.

Embodiment 69. A seatpost assembly comprising: a lower post; an upper post movable relative to the lower post between a high position and a low position; and a height change assembly comprising a motor configured to drive the upper post between the high position and the low position.

Embodiment 70. The seatpost assembly of embodiment 69, wherein the motor is coupled to the upper post through an energy storage device.

Embodiment 71. The seatpost assembly of embodiment 70, wherein the energy storage device is configured to: store energy generated by the motor; and release the stored energy to drive the upper post from a current position of the high and low positions to the other of the high and low positions.

Embodiment 72. The seatpost assembly of embodiment 71, wherein the stored energy is mechanically stored by a linear spring, a rotational spring, or a combination thereof.

Embodiment 73. The seatpost assembly of embodiment 71, wherein the energy storage device is configured to store a prescribed threshold amount of stored energy received from the motor.

Embodiment 74. The seatpost assembly of embodiment 73, wherein the energy storage device is configured to dissipate excess energy received from the motor after the energy storage device reaches the prescribed threshold of stored energy.

Embodiment 75. The seatpost assembly of embodiment 70, wherein the motor is configured to impart energy to the energy storage device in response to receiving a signal from an actuation assembly configured to receive a user input.

Embodiment 76. The seatpost assembly of embodiment 70, further comprising: an actuation assembly configured to receive a user input; and a locking assembly configured to lock the upper and lower posts in the upper position; wherein, responsive to receiving the user input, the actuation assembly controls: the locking assembly to unlock the upper and lower posts; the locking assembly to re-lock the upper and lower posts; and the motor to impart energy to recharge the energy storage device.

Embodiment 77. The seatpost assembly of any one or more of embodiments 69 to 76, wherein the motor is coupled to a power source, and wherein the power source is disposed at least partially within at least one of the upper or lower posts.

Embodiment 78. The seatpost assembly of embodiment 77, further comprising an actuation assembly configured to receive a user input, the user input operable to control the height change assembly, wherein the power source comprises: a first power unit disposed at least partially within at least one of the upper or lower posts; and a second power unit associated with the actuation assembly and disposed entirely outside of the upper and lower posts.

Embodiment 79. The seatpost assembly of embodiment 78, wherein the actuation assembly and the height change assembly communicate through an electrical conductor.

Embodiment 80. The seatpost assembly of any one or more of embodiments 69 to 79, wherein at least a portion of the motor is disposed outside at least one of the upper and lower posts when the upper post is in the lower position.

Embodiment 81. A seatpost assembly comprising: a seatpost positionable between an extended state and a retracted state; and an actuation assembly comprising an actuator, the actuator operably coupled to the seatpost, the actuator movable between a first position and a second position; wherein the seatpost moves from the extended state to the retracted state responsive to the actuator moving from the first position to the second position, and wherein the seatpost moves from the retracted state to the extended state responsive to the actuator moving from the first position to the second position.

Embodiment 82. The seatpost assembly of embodiment 81, wherein operation of the actuator provides the motive force to move the seatpost: from the extended state to the retracted state responsive to the actuator moving from the first position to the second position, and from the retracted state to the extended state responsive to the actuator moving from the first position to the second position.

Embodiment 83. The seatpost assembly of any one or more of embodiments 81 or 82, further comprising a height change assembly, wherein the height change assembly is configured to transmit motive force to move the seatpost: from the extended state to the retracted state responsive to the actuator moving from the first position to the second position, and from the retracted state to the extended state responsive to the actuator moving from the first position to the second position.

Embodiment 84. The seatpost assembly of embodiment 83, wherein the height change assembly is configured to transmit a mechanical force from the actuator to the seatpost.

Embodiment 85. The seatpost assembly of embodiment 83, wherein the height change assembly comprises: an electromechanical drive; and a power source; wherein the electromechanical drive is configured to use power from the power source to apply a mechanical force to the seatpost responsive to operation of the actuator.

Embodiment 86. The seatpost assembly of embodiment 85, wherein the power source is removable from the seatpost.

Embodiment 87. The seatpost assembly of embodiment 85, wherein the actuation assembly further comprises a wireless transmitter and wherein the height change assembly further comprises a wireless receiver, the wireless receiver of the height change assembly configured to generate an operation signal responsive to receiving an actuation signal from the wireless transmitter of the actuation assembly.

Embodiment 88. A method of positioning a seatpost between a plurality of states, the method comprising: receiving, at a height change assembly of the seatpost, a first input; causing, by the height change assembly, the seatpost to move from an extended state to a retracted state in response to the first input; receiving, at the height change assembly, a second input while the seatpost is in the retracted state; and causing, by the height change assembly, the seatpost to move from the retracted state to the extended state in response to the second input, wherein the first input and the second input are the same.

Embodiment 89. The method of embodiment 88, further comprising: locking, with a locking assembly, the seatpost in the extended state.

Embodiment 90. The method of embodiment 89, further comprising locking, with the locking assembly the seatpost in the retracted state.

Embodiment 91. The method of embodiment 90, further comprising: locking, with a first lock of the locking assembly, the seatpost in the extended state; and locking, with a second lock of the locking assembly, the seatpost in the retracted state.

Embodiment 92. A method of configuring a seatpost assembly between a plurality of states, the method comprising: switching a seatpost between an extended state and retracted state, wherein switching the seatpost comprises: causing, by a height change assembly, a seatpost to move from an extended state to a retracted state in response to a first input; and causing, by the height change assembly, the seatpost to move from the retracted state to the extended state in response to a second input; wherein the seatpost is movable by the height change assembly between the extended state and the retracted state indefinitely prior to a servicing operation.

Embodiment 93. The method of embodiment 92, wherein the seatpost is movable by the height change assembly between the extended state and the retracted state at least 100 times prior to the servicing operation.

Embodiment 94. The method of any one or more of embodiments 92 or 93, wherein the height change assembly comprises a linkage.

Embodiment 95. A seatpost assembly comprising: a lower post having a non-circular cross-sectional shape; an upper post movable relative to the lower post between a high position and a low position; and a height change assembly operable to drive the upper post from the low position to the high position.

Embodiment 96. The seatpost assembly of embodiment 95, wherein the lower post comprises a first cross-sectional shape, wherein the upper post comprises a second cross-sectional shape, and wherein the first and second cross-sectional shapes are different from one another.

Embodiment 97. The seatpost assembly of any one or more of embodiments 95 or 96, wherein the lower post comprises a first cross-sectional shape, wherein the upper post comprises a second cross-sectional shape, and wherein the first and second cross-sectional shapes are generally the same as one another.

Embodiment 98. The seatpost assembly of any one or more of embodiments 95 to 97, wherein the upper post has a teardrop cross-sectional shape.

Embodiment 99. The seatpost of any one or more of embodiments 95 to 98, wherein the height change assembly is disposed within a volume defined by the upper and lower posts.

Embodiment 100. The seatpost of any one or more of embodiments 95 to 99, wherein the height change assembly is operable to drive the upper post from the high position to the low position.

Embodiment 101. A method of positioning a seatpost assembly between a plurality of states, the method comprising: storing, with an energy storage device, energy from a height change assembly; releasing, with a locking assembly, energy stored with the energy storage device; and storing, with the energy storage device, energy from the height change assembly responsive to the releasing of the energy stored with the energy storage device.

Embodiment 102. The method of embodiment 101, further comprising: locking, with the locking assembly, a seatpost in an extended position responsive to releasing, with the locking assembly, energy stored with the energy storage device.

Embodiment 103. The method of any one or more of embodiments 101 or 102, further comprising: detecting, with a sensor, energy stored with the energy storage device; and determining, with a processor, if energy stored with the energy storage device has achieved a threshold.

Embodiment 104. The method of embodiment 103, further comprising: refusing releasing, with the locking assembly, energy stored with the energy storage device unless the energy storage device has determined, with the processor, that energy stored with the energy storage device has achieved the threshold.

Embodiment 105. The method of embodiment 103, further comprising:

generating, with the processor, a ready signal if the processor determines that energy stored with the energy storage device has achieved the threshold.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A seatpost assembly comprising:
a lower post;
an upper post movable relative to the lower post between a high position and a low position;
an actuation assembly configured to receive a user input; and
a height change assembly operable to drive the upper post to the high position responsive to receiving the user input and to drive the upper post to the low position responsive to receiving the user input, both without application of rider weight.

2. The seatpost assembly of claim 1, wherein the user input is the same to drive the upper post to the high position and to drive the upper post to the lower position.

3. The seatpost assembly of claim 1, wherein the height change assembly is essentially free of an air pressure vessel.

4. The seatpost assembly of claim 1, wherein the upper post is movable by the height change assembly from the high position to the low position indefinitely prior to a servicing operation.

5. The seatpost assembly of claim 1, wherein the height change assembly comprises:
a motor having an output shaft to drive the upper post, wherein the output shaft is disposed in the lower post; and
a power source electrically coupled to the motor.

6. The seatpost assembly of claim 1, further comprising a spring, the spring operable to:
store energy generated by the height change assembly;
release stored energy to drive the upper post to the high position responsive to receiving the user input; and
release stored energy to drive the upper post to the low position responsive to receiving the user input.

7. The seatpost assembly of claim 6, wherein the spring is coupled to an energy storage unit, wherein the height change assembly is operable to drive the energy storage unit in:
a first direction to store a stored lifting energy; and
a second direction, different to the first direction, to store a lowering energy;
wherein the stored lifting energy is released to drive the upper post to the high position responsive to receiving the user input; and
wherein the stored lowering energy is released to drive the upper post to the low position responsive to receiving the user input.

8. The seatpost assembly of claim 7, further comprising a locking assembly, wherein release of the stored lifting energy and the stored lowering energy is controlled by the locking assembly.

9. A seatpost assembly comprising:
a lower post;
an upper post movable relative to the lower post between a high position and a low position, wherein the upper post is configured to receive a saddle; and
a height change assembly comprising a motor that drives the upper post relative to the lower post between the high position and the low position.

10. The seatpost assembly of claim 9, wherein the motor is coupled to the upper post through an energy storage device.

11. The seatpost assembly of claim 10, wherein the energy storage device is configured to:
store energy generated by the motor; and
release the stored energy to drive the upper post from a current position of the high and low positions to the other of the high and low positions.

12. The seatpost assembly of claim 11, wherein the stored energy is mechanically stored by a spring.

13. The seatpost assembly of claim 9, further comprising:
an actuation assembly configured to receive a user input; and
a locking assembly configured to lock the upper and lower posts in at least the upper position;
wherein, responsive to receiving the user input, the actuation assembly controls:
the locking assembly to unlock the upper and lower posts from one another;
the locking assembly to re-lock the upper and lower posts together; and
the motor to impart energy to recharge the energy storage device.

14. The seatpost assembly of claim 9, wherein the motor is electrically coupled to a power source, and wherein the power source is coupled to the upper post.

15. The seatpost assembly of claim 9, wherein at least a portion of the motor is disposed inside the lower post, and wherein the motor comprises a threaded rod output shaft that extends into the upper post when the upper post is in at least the low position.

16. A seatpost assembly comprising:
a seatpost positionable between an extended state and a retracted state; and
an actuation assembly comprising an actuator, the actuator operably coupled to the seatpost, the actuator movable between a first position and a second position;
wherein the seatpost moves from the extended state to the retracted state responsive to the actuator moving from the first position to the second position, and
wherein the seatpost moves from the retracted state to the extended state responsive to the actuator moving from the first position to the second position.

17. The seatpost assembly of claim 16, wherein operation of the actuator provides the motive force to move the seatpost:
from the extended state to the retracted state responsive to the actuator moving from the first position to the second position, and
from the retracted state to the extended state responsive to the actuator moving from the first position to the second position.

18. The seatpost assembly of claim 16, further comprising a height change assembly, wherein the height change assembly is configured to transmit motive force to move the seatpost:
from the extended state to the retracted state responsive to the actuator moving from the first position to the second position, and
from the retracted state to the extended state responsive to the actuator moving from the first position to the second position.

19. The seatpost assembly of claim 18, wherein the height change assembly comprises:
an electromechanical drive; and
a power source;
wherein the electromechanical drive is configured to use power from the power source to apply a mechanical force to the seatpost responsive to operation of the actuator.

20. The seatpost assembly of claim 18, wherein the actuation assembly further comprises a wireless transmitter and wherein the height change assembly further comprises a wireless receiver, the wireless receiver of the height change assembly configured to generate an operation signal responsive to receiving an actuation signal from the wireless transmitter of the actuation assembly.
